(19) United States
(12) Patent Application Publication
(10) Pub. No.: US 2010/0075070 A1
(43) Pub. Date: Mar. 25, 2010

(54) OPTICAL FILM, POLARIZING PLATE, AND LIQUID CRYSTAL DISPLAY DEVICE

(75) Inventors: Michio NAGAI, Minami-ashigara-shi (JP); Akira Yamamoto, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/562,484

(22) Filed: Sep. 18, 2009

(30) Foreign Application Priority Data
Sep. 22, 2008 (JP) 2008-242219

(51) Int. Cl. C09K 19/54; F21V 9/14

(52) U.S. Cl. 428/1.31; 252/299.5; 252/585

(57) ABSTRACT

The invention relates to an optical film comprising a first optically anisotropic layer formed of a composition comprising, at least, a liquid crystal compound and a fluorinated surfactant, and a second optically anisotropic layer comprising at least one selected from the group consisting of cycloolefin base homopolymers and copolymers, wherein a dynamic friction coefficient between the two sides of the optical film is equal to or smaller than 1.0.

### CROSS-REFERENCE TO RELATED APPLICATIONS

This application claims benefit of priority under 35 U.S.C. 119 to Japanese Patent Application No. 2008-242219, filed on Sep. 22, 2008, which is expressly incorporated herein by reference in its entirety.

### BACKGROUND OF THE INVENTION

1. Technical Field

The invention relates to an optical film and a polarizing plate which can contribute to optical compensation of liquid crystal display devices, and a liquid crystal display device having the same.

2. Background Art

Various optical compensation films, having a support formed on a polymer film and an optically anisotropic layer formed of a liquid crystal composition thereon, have been proposed. The optically anisotropic layer may be prepared according to a method comprising preparing a coating liquid containing a liquid crystal compound and applying with the coating liquid to a surface. Adding fluorinated surfactant(s) to the coating liquid has been proposed for controlling the tilt angles of liquid crystal molecules (JP-A-2005-62673).

According to a method for continuously preparing the optical compensation film, having such a structure, generally, an optically anisotropic layer is formed on a surface of a long film continuously while the long film is fed. When the film has a low slip-property, the productivity may be lowered due to wrinkle or the like. The means for improving the slip-property of the films have been proposed (JP-A-2007-261052 and JP-A-2006-163033).

### SUMMARY OF THE INVENTION

The optical compensation film described above may be winded up after being prepared in the continuous manner, and then may be preserved or carried in the wind-up state. When the long optical compensation film is winded up, the slip-property between the surface of the optically anisotropic layer and the rear face of the support, that is, a polymer film, is important. Therefore, improvement in only the slip-property of the polymer film may be insufficient, and such an improvement may not contribute to improvement in the productivity of the optical compensation film as a whole. Especially, many optically anisotropic layers containing the fluorinated surfactant, which is capable of controlling the alignment, may have a surface of high smoothness, and any wrinkles and pleats may occur easily. Therefore, it is difficult to produce optical compensation films, having good qualities, with a high productivity.

One object of the invention is to improve the productivity of optical films, having an optically anisotropic layer formed of a liquid crystal composition. More specifically, objects of the invention are to provide an optical film, having a good quality, which can be prepared with a high productivity, and to provide a polarizing plate and a liquid crystal display device having the optical film.

The means for achieving the objects are as follows.

[1] An optical film comprising:

a first optically anisotropic layer formed of a composition comprising, at least, a liquid crystal compound and a fluorinated surfactant, and

a second optically anisotropic layer comprising at least one selected from the group consisting of cycloolefin base homopolymers and copolymers,

wherein a dynamic friction coefficient between the two sides of the optical film is equal to or smaller than 1.0.

[2] The optical film of [1], wherein the first optically anisotropic layer has a surface roughness of equal to or more than 0.8 nm.
[3] The optical film of [1] or [2], wherein the fluorinated surfactant has one or more poly(alkyleneoxy) groups.
[4] The optical film of any one of [1] to [3], wherein the fluorinated surfactant is a polymer comprising a repeating unit derived from a compound represented by formula (I) and a repeating unit derived from a compound represented by formula (II); and the molar ratio of the repeating unit of formula (II) in the polymer is equal to or more than 10% by mole:

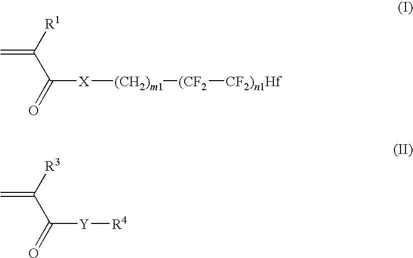

where Hf represents a hydrogen atom or fluorine atom; R¹ represents a hydrogen atom or methyl; X represents an oxygen atom, sulfur atom or —N(R²)—; m1 is an integer of from 1 to 6; n1 is an integer of from 2 to 4; R² represents a hydrogen atom or C₁₋₄ alkyl; R³ represents a hydrogen atom or methyl; Y represents a bivalent liking group; and R⁴ represents a poly(alkyleneoxy) group which may have at least one substituent.

[5] The optical film of [4], wherein the monomer represented by formula (II) is a compound represented by formula (II′) shown below:

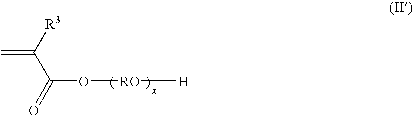

where R³ has a same meaning as that defined in formula (II); R represents a C₂₋₄ alkylene; x is an integer from 2 to 10, provided that plural alkyleneoxy units, RO, are same or different from each other.

[6] The optical film of any one of [1] to [5], wherein the one liquid crystal compound is a discotic compound.
[7] The optical film of any one of [1] to [6], wherein the second optically anisotropic layer comprises inorganic fine particles and/or polymer fine particles.
[8] The optical film of any one of [1] to [7], wherein |Δn|, which is an absolute value of the difference in refractive index between the particles and at least one selected from the group consisting of cycloolefin base homopolymers and copolymers, and r (μm), which is the mean particle diameter of the particles, meet |n|·r≦0.05 (μm).
[9] A polarizing plate comprising a polarizing film and an optical film according to any one of [1] to [8].
[10] A liquid crystal display comprising a liquid crystal cell and a polarizing plate according to [9].
[11] The liquid crystal display of [10], wherein the liquid crystal cell employs a TN-mode.

According to the invention, it is possible to improve the productivity of optical films, having an optically anisotropic layer formed of a liquid crystal composition. More specifically, according to the invention, it is possible to provide an optical film, having a good quality, which can be prepared with a high productivity, and to provide a polarizing plate and a liquid crystal display device having the optical film.

### DETAILED DESCRIPTION OF THE INVENTION

The invention is described in detail hereinunder. Note that, in this patent specification, any numerical expressions in a style of “numerical value 1 to numerical value 2” will be used to indicate a range including the lower and upper limits.

### 1. Optical Film

The present invention relates to an optical film having a first optically anisotropic layer formed of a composition comprising, at least, a liquid crystal compound and a fluorinated surfactant, and a second optically anisotropic layer comprising at least one selected from the group consisting of cycloolefin base homopolymers and copolymers. According to the invention, by adding a fluorinated surfactant to the first optically anisotropic layer, the unevenness of the film plane thereof is reduced and the desired optical properties thereof are obtained; and in addition, by adding a fluorinated surfactant to the first optically anisotropic layer, the smoothness of the surface thereof is improved compared with that containing no fluorinated surfactant. According to the invention, as the second optically anisotropic layer, a polymer film containing at least one selected from the group consisting of cycloolefin base homopolymers and copolymers is used. The film has the advantages such as showing the optical properties which are suitable for optical compensation in combination with the first optically anisotropic layer and showing low-permeability which may be required for any member to be used in liquid crystal display devices. On the other hand, the film has disadvantages of showing a high friction coefficient and showing the low slip-property. Accordingly, when the optical film is prepared continuously by applying a coating liquid to the surface of the film, containing at least one selected from the group consisting of cycloolefin base homopolymers and copolymers, some wrinkles and pleats may occur in the film, which may lower the productivity. According to the invention, by adjusting the dynamic friction coefficient between the two sides of the optical film to the range of equal to or smaller than 1.0, it is possible to solve the above mentioned problem and to provide an optical film, having a good quality, with a high productivity.

The dynamic friction coefficient between the two sides of the optical film of the invention is equal to or smaller than 1.0, preferably equal to or smaller than 0.8, and more preferably equal to or smaller than 0.6. In terms of the productivity, the lower dynamic friction coefficient is more preferable. Generally, the lowest limitation of the dynamic friction coefficient may be about 0.2. When the dynamic friction coefficient between the two sides fall within the range, the slip-property during the wind-up step is improved, and so wrinkles or pleats may occur hardly, thereby improving the yield.

In the description, the dynamic friction coefficient between the two sides of an optical film can be measured as follows. A film sample is disposed in an environment at a temperature of 23 degrees Celsius and a relative humidity of 55% RH so that the two sides of the film contact with each other. And then the measurement is carried out according to a method of JIS-K7125, and the dynamic friction coefficient can be obtained.

Next, the first and second optically anisotropic layers will be described in detail.

### 1.-1 First Optically Anisotropic Layer

According to the invention, the first optically anisotropic layer is a layer formed of a composition at least containing a liquid crystal compound and a fluorinated surfactant. For adjusting the dynamic friction coefficient between the two sides of the optical film to the range, the smoothness of the surface of the first optically anisotropic layer is preferably lowered in a certain degree. Form this viewpoint, the surface roughness, Ra, of the first optically anisotropic layer is preferably equal to or more than 0.8 nm, more preferably equal to or more than 0.9, and even more preferably equal to or more than 1.0 nm. In terms of the productivity, the higher surface roughness Ra is more preferable; on the other hand, increasing the surface roughness can be a factor of increasing the haze value. Any member to be used in liquid crystal display devices is required to show haze of equal to or smaller than 10%. For achieving such a property, Ra of the first optically anisotropic layer is preferably equal to or smaller than 2.0 nm.

The surface roughness Ra of an optically anisotropic layer can be measured by using AFM (Atomic Force Microscope such as “SPI3800N” manufactured by SEIKO Instruments Inc.).

According to the invention, as described above, it is preferable that the smoothness of the surface of the first optically anisotropic layer is lowered at the certain degree, however, the first optically anisotropic layer contains a fluorinated surfactant, and such a surface has higher smoothness compared with a layer not containing such a surfactant. The inventors conducted various studies; and as a result, they found that among various fluorinated surfactants, fluorinated surfactants having poly(alkyleneoxy) group(s) have not only abilities of improving the surface state of the layer and controlling the optical properties, but also abilities of lowering the surface smoothness of the layer at a certain degree, that is, of adjusting the surface roughness (Ra) to the range. Especially, polymers having a repeating unit derived from the compound represented by formula (I) and a repeating unit derived from the compound represented by formula (II), whose molar ratio is equal to or more than 10 mole %, are preferable in terms of adjusting the surface roughness (Ra) of the first optically anisotropic layer to the range easily.

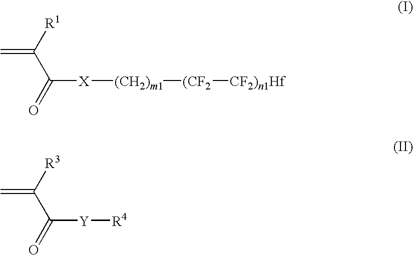

where Hf represents a hydrogen atom or fluorine atom; R¹ represents a hydrogen atom or methyl; X represents an oxygen atom, sulfur atom or —N(R²)—; m1 is an integer of from 1 to 6; n1 is an integer of from 2 to 4; R² represents a hydrogen atom or C₁₋₄ alkyl; R³ represents a hydrogen atom or methyl; Y represents a bivalent liking group; and R⁴ represents a poly(alkyleneoxy) group which may have at least one substituent.

Preferable examples of the polymer include acryl-base polymers, methacryl-base polymers and their copolymers with any vinyl monomer capable of polymerizing with them, having a repeating unit derived from the compound represented by formula (I) and a repeating unit derived from the compound represented by formula (II).

The fluoroaliphatic group-containing monomer represented by formula (I) may be prepared according to a telomerization method, occasionally referred to as telomer method, or an oligomemerization, occasionally referred to as oligomer method. Examples of preparation of the fluoroaliphatic compound are group-containing compound are described on pages 117 to 118 in “Synthesis and Function of Fluoride Compounds (Fussokagoubutsu no Gousei to Kinou)” overseen by ISHIKAWA NOBUO and published by CMC Publishing Co., Ltd. in 1987; and on pages 747 to 752 in “Chemistry of Organic Fluorine Compounds II”, Monograph 187, Ed by Milos Hudlicky and Attila E. Pavlath, American Chemical Society 1995; and the like. The telomerization method is a method for producing a telomer by carrying out radical polymerization of fluorine-containing compound such as tetrafluoroethylene in the presence of an alkylhalide such as iodide, having a large chain-transfer constant number, as a telogen. One example is shown in Scheme-I.

R—I+nF₂C═CF₂→RCF₂CF₂ₙI Scheme 1

The obtained fluorine-terminated telomers are usually terminal-modified properly as shown in Scheme 2, to give fluoro-aliphatic compounds. The compounds may be changed to a preferable monomer structure, if necessary; and then, such a compound may be used in preparing the fluorinated polymers

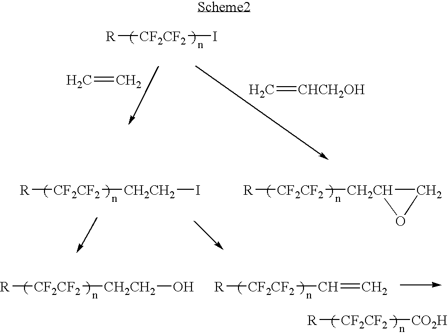

In formula (I), R¹ represents a hydrogen atom or methyl; X represents an oxygen atom, sulfur atom or —N(R²)—; and Hf represents a hydrogen atom or fluorine atom. R² represents a hydrogen atom or C₁₋₄ alkyl such as methyl, ethyl, propyl and butyl; and R² is preferably a hydrogen atom or methyl. X is preferably an oxygen. In formula (I), m1 is an integer from 1 to 6, and preferably 1 or 2. In formula (II), n1 is an integer from 2 to 4, and more preferably 2 or 3. And the mixture thereof may be also used.

Examples of the fluoroaliphatic group-containing monomer, represented by formula (I), include, but are not limited to, those shown below.

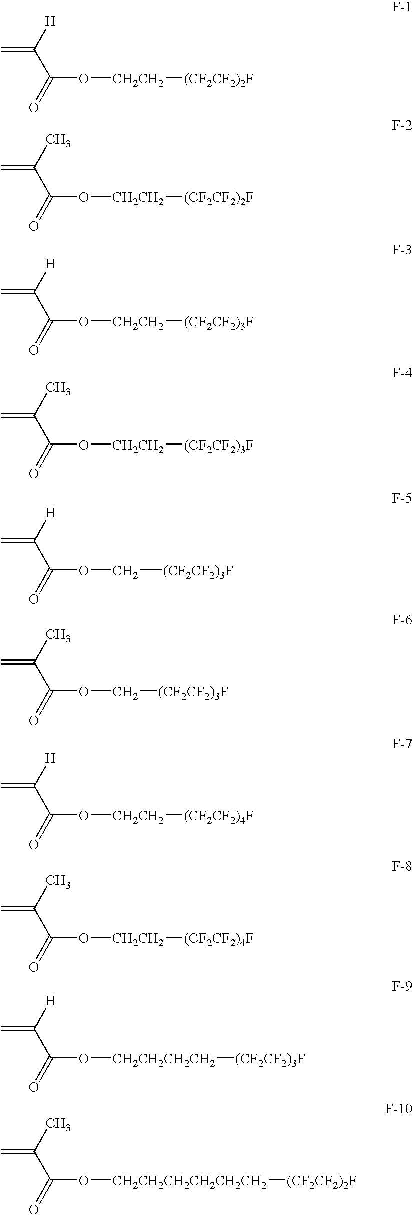

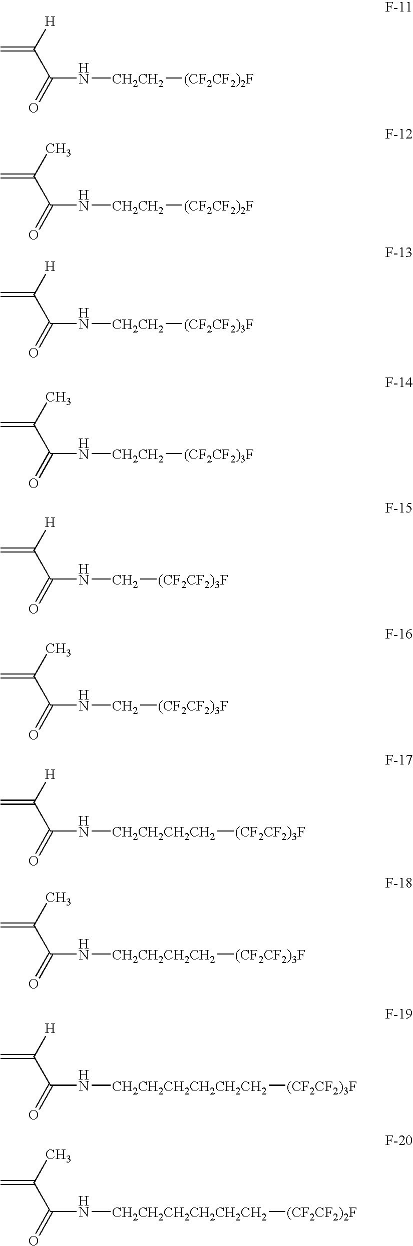

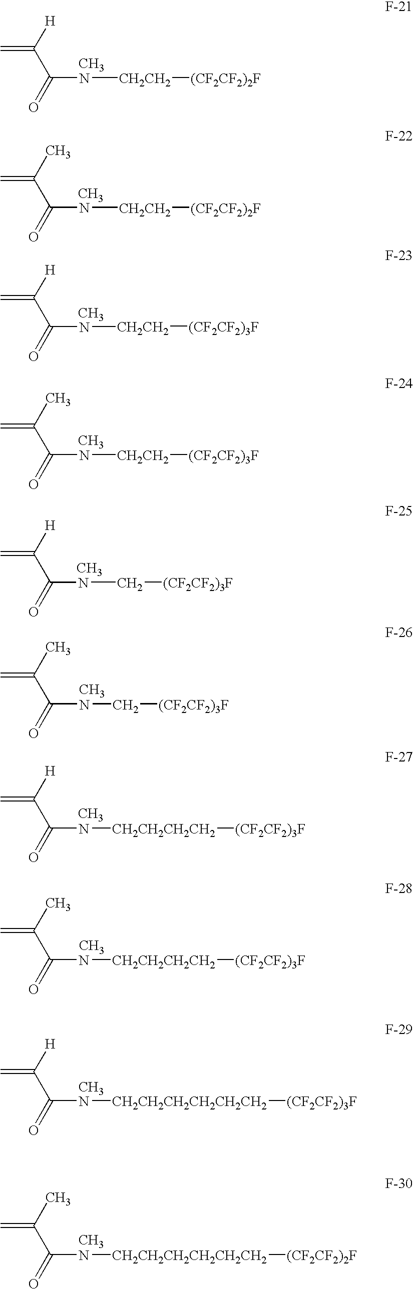

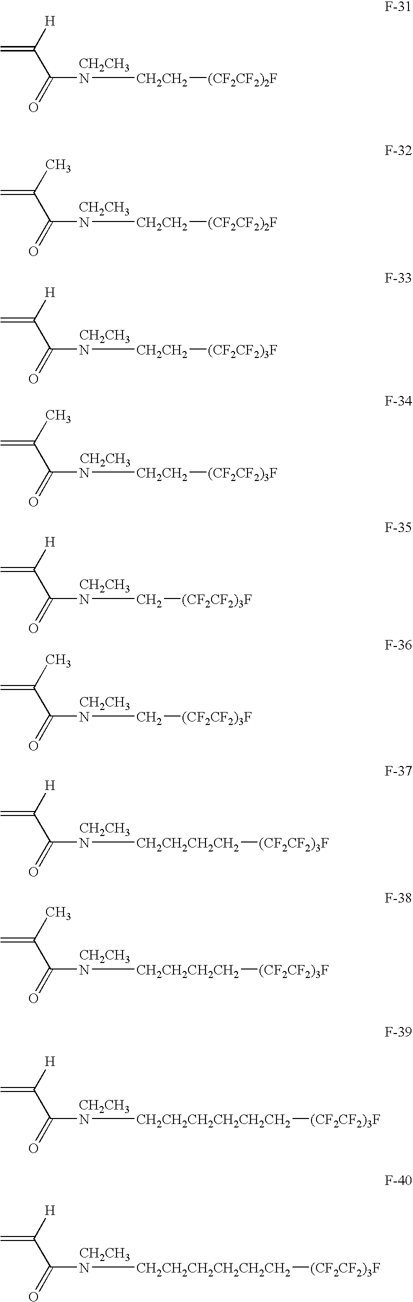

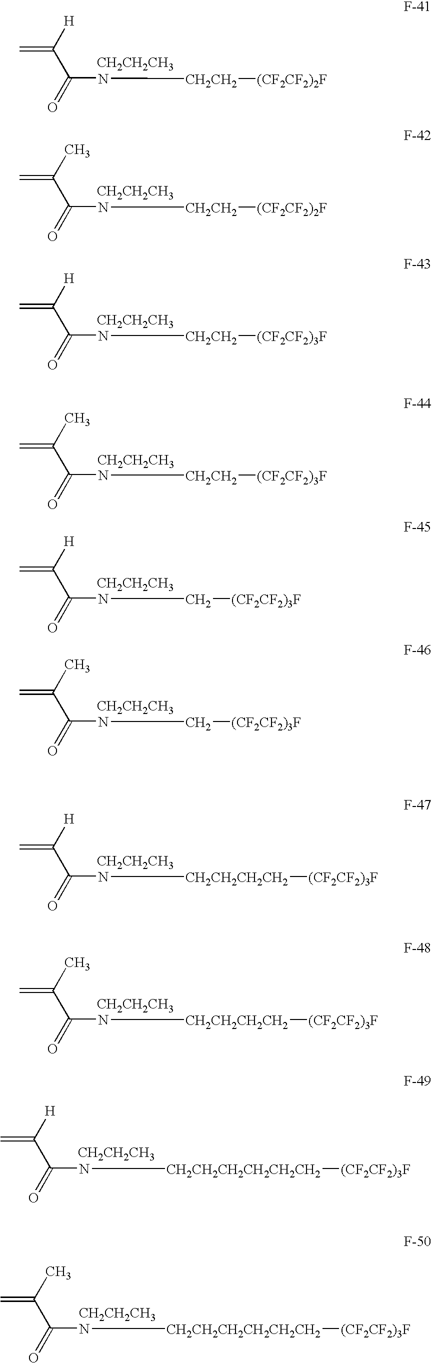

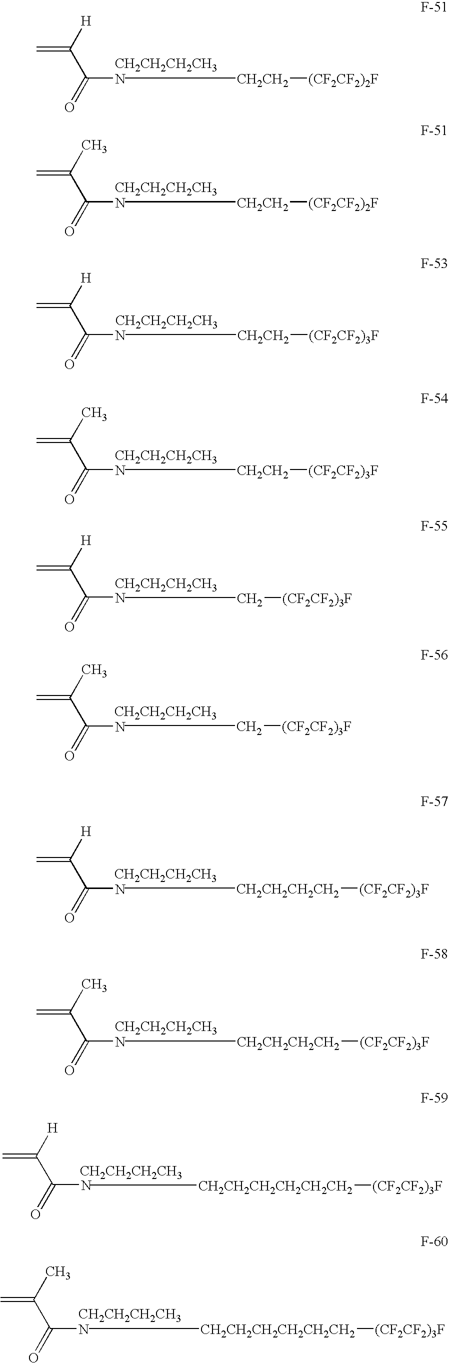

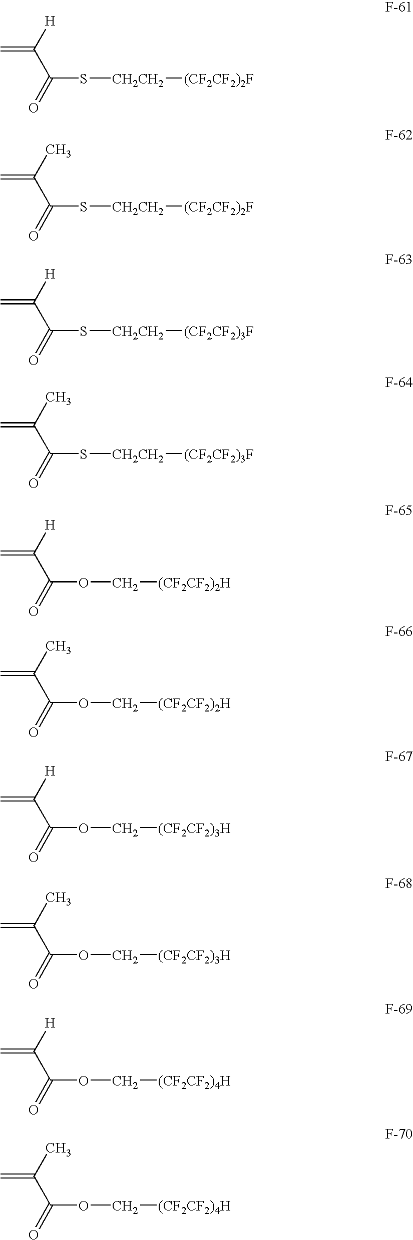

In formula (II), R³ represents a hydrogen atom or methyl; and Y is a divalent liking group. Examples of the divalent linking group include an oxygen atom, a sulfur atom, or —N(R⁵)—. R⁵ represents a hydrogen atom or C₁₋₄ alkyl such as methyl, ethyl, propyl and butyl. Preferable examples of R⁵ include a hydrogen atom and methyl.

Y preferably represents an oxygen atom, —N(H)— or —N(CH₃)—.

R⁴ represents a poly (alkyleneoxy) group which may have one or more substituents.

Examples of the poly (alkyleneoxy) group represented by R⁴ include (RO)ₓ; R represents C₂₋₄ alkylene group such as —CH₂CH₂—, —CH₂CH₂CH₂—, —CH(CH₃)CH₂—, and —CH(CH₃)CH(CH₃)—. The alkyleneoxy units contained in the poly (alkyleneoxy) group may be same with each other as well as poly(propyleneoxy), or may be different from each other, so that plural alkyleneoxy randomly appear, so that linear or branched propyleneoxy units and ethyleneoxy units appear, or so that linear or branched propyleneoxy blocks and ethyleneoxy blocks appear. Examples of the poly(alkyleneoxy) chain include any structures wherein plural poly(alkylneoxy) units are linked via one or more linking group (such as —CONH-Ph-NHCO— and —S—, where Ph is phenylene). When the bonding sites in the linking group are equal to or more than 3, branched alkylneoxy units may be obtained. And the molecular weight of the poly(alkyleneoxy) group is generally from 250 to 3000.

In the poly(alkyleneoxy) group, (RO)ₓ, when R is C₂₋₄ alkylene, x is preferably from 2 to 10.

The poly(alkyleneoxy) group represented by R⁴ may have one or more substituents. Examples of the substituent include hydroxy, alkylcarbonyl, arylcarbonyl, alkylcarbonyloxy, carboxyl, alkylether, arylether, halogen atom such as fluorine atom, chlorine atom, and bromine atom, nitro, cyano, and amino, but are not limited to these.

Examples of the monomer represented by formula (II) include those represented by formula (II′).

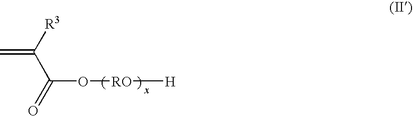

Where R³ has a same meaning as that defined in formula (II); R represents a C₂₋₄ alkylene; x is an integer from 2 to 10, provided that plural alkyleneoxy units, RO, are same or different from each other.

Preferable examples of the monomer represented by formula (II) include poly(alkyleneoxy) (meth)acrylates.

Examples of the monomer represented by formula (II) include, but are not limited to, those shown below.

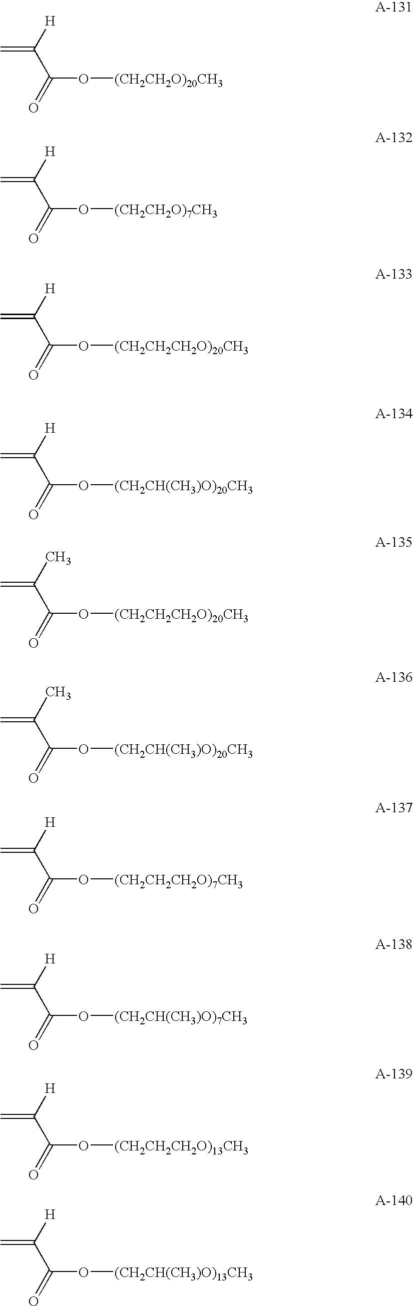

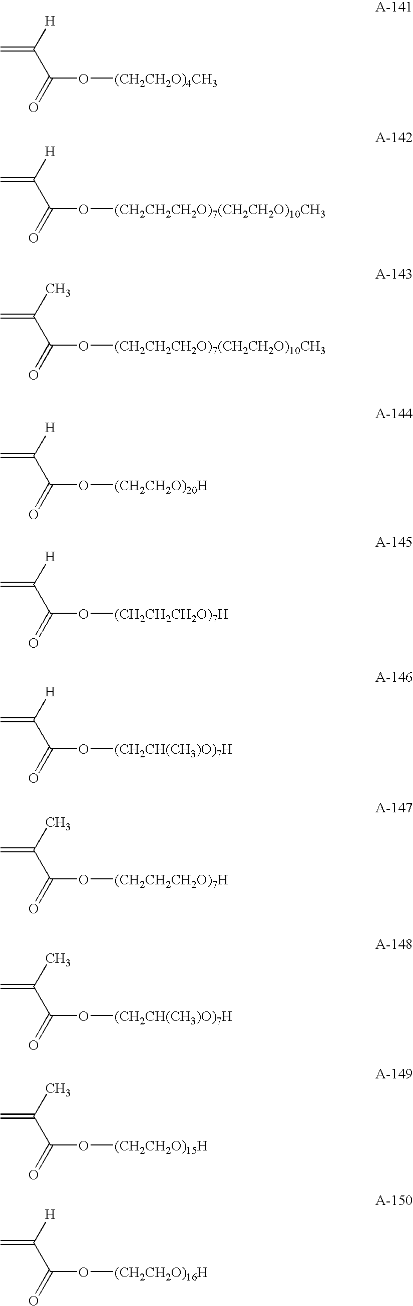

Poly(alkyleneoxy)acrylates and poly(alkyleneoxy)methacrylates may be prepared as follows. A hydroxy poly(alkyleneoxy) material, which is commercially available, such as “Pluronic” (ADEKA CORPORATION), “ADEKA Polyether” (ADEKA CORPORATION), “Carbowax” (Glyco•Producs), “Toriton” (Rohm and Haas) and “P.E.G” (DAI-ICHI KOGYO SEIYAKU CO., LTD.) is allowed to react with acrylic acid, methacrylic acid, acryl chloride, methacryl chloride or acrylic acid anhydrite according to any known method. Poly(oxyalkylene)diacrylates which can be prepared according to any known method may be used.

The fluorinated surfactant to be used in the invention is preferably selected from the copolymers of the monomer represented by formula (I) and poly(alkyleneoxy)(meth)acrylate; and more preferably selected from the copolymers of the monomer represented by formula (I) and polyethylene oxy)(meth)acrylate or poly(propyleneoxy) (meth)acrylate.

According to the invention, it is preferable that the fluorinated surfactant is a copolymer having a repeating unit derived from a compound represented by formula (I) and a repeating unit derived from a compound represented by formula (II), whose molar ratio is equal to or more than 10% by mole. The copolymer is referred to as “fluorinated polymer” hereinunder. When the molar ratio of the compound represented by formula (II) is adjusted to the range, fine asperity may be formed on the surface of the first optically anisotropic layer and Ra of the layer may be adjusted to the desired range. From this point of view, the molar ratio of formula (II) is preferably equal to or more than 30% by mole, and more preferably equal to or more than 50% by mole. On the other hand, in terms of the original purpose of improving smoothness of the layer and controlling the optical properties, the molar ratio of formula (I) is preferably equal to or more than 20% by mole, or that is, the molar ratio of formula (II) is preferably equal to or smaller than about 80% by mole.

The fluorinated polymer to be used in the invention may have other repeating unit(s) derived from other monomer(s) along with the repeating units derived from the monomers represented by formula (I) and (II). The other monomer may be used mainly with the aim of adjusting the optical properties. Examples of such other monomer(s) include those described in Polymer Handbook 2nd ed., J. Brandrup, Wiley Interscience (1975) Chapter 2, Page 1-483. The other monomer(s) may be selected from any compounds, having an addition polymerizable unsaturated group, such as acrylic acid, methacrylic acid, acrylates, methacrylates, acrylamides, methacrylamides, allyl compounds, vinyl ethers and vinyl esters.

More specifically, the examples of the other monomer(s) are as follows.

### Acrylates:

Furfuryl acrylate, tetrahydro furfuryl acrylate and so forth;

### Methacrylates:

Furfuryl methacrylate, tetrahydro furfuryl methaacrylate and so forth;

### Allyl Compounds:

Allyl esters such as allyl acetate, allyl caproate, allyl caprylate, allyl laurate, allyl palmitate, allyl stearate, allyl benzoate, allyl acetoacetate, and ally lactate; allyl oxy ethanol and so forth;

### Vinyl Ethers:

Alkyl vinyl ether such as hexyl vinyl ether, octyl vinyl ether, decyl vinyl ether, ethyl hexyl vinyl ether, methoxy ethyl vinyl ether, ethoxy ethyl vinyl ether, chloroethyl vinyl ether, 1-methyl-2,2-dimethyl propyl vinyl ether, 2-ethyl butyl vinyl ether, hydroxy ethyl vinyl ether, diethylene glycol vinyl ether, dimethyl amino ethyl vinyl ether, diethyl amino ethyl vinyl ether, butyl amino ethyl vinyl ether, benzyl vinyl ether and tetrahydro furfuryl vinyl ether;

### Vinyl Esters:

Vinyl butyrate, vinyl isobutyrate, vinyl trimethyl acetate, vinyl diethyl acetate, vinyl valate, vinyl caproate, vinyl chloro acetate, vinyl dichloro acetate, vinyl methoxy acetate, vinyl butoxy acetate, vinyl lactate, vinyl-β-phenyl butyrate and vinyl cyclohexyl carboxylate;

### Diallyl Itaconates:

Dimethyl itaconate, diethyl itaconate, dibutyl itaconate and so forth; Dialkyl or monoalkyl fumarates:

Dibutyl fumarate and so forth

### Other Monomers:

Crotonic acid, itaconic acid, acrylonitrile, methacrylonitrile, maleylonitrile, styrene and so forth.

The mean weight-averaged molecular weight of the fluorinated polymer is preferable from 3,000 to 100,000, and more preferably from 6,000 to 80,000.

The fluorinated polymer may be prepared according to any know method. For example, the fluorinated polymer may be prepared by carrying out polymerization of the monomers such as (meth)acrylate having a fluoroaliphatic group and (meth)acrylate having a poly(alkylene oxy) group in an organic solvent added with any known radical polymerization initiator. If necessary, other addition-polymerizable monomer(s) may be added to the solvent. Depending on the polymerization abilities of the monomers to be used, drop polymerization in which polymerization is carried out while monomer(s) and polymerization initiator(s) are added to the polymerization series dropwise may be employed. This method is advantageous in terms of obtaining polymers having a uniform formulation.

Examples of the fluorinated polymer include, but are not limited to, those shown below. The numbers in the formulae indicate molar ratios; and “Mw” indicates a mean weight averaged molecular weight thereof.

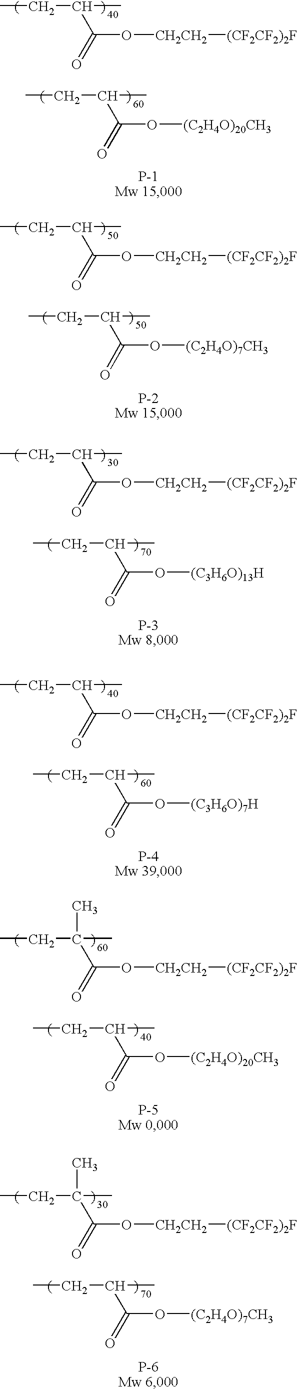

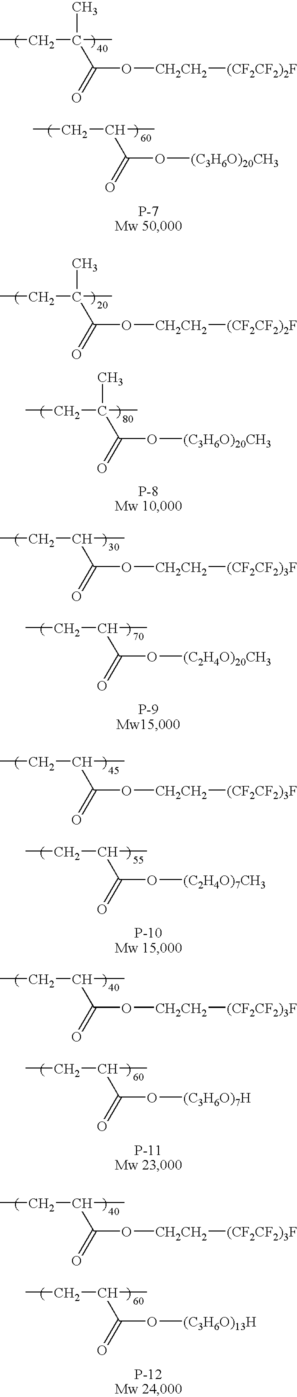

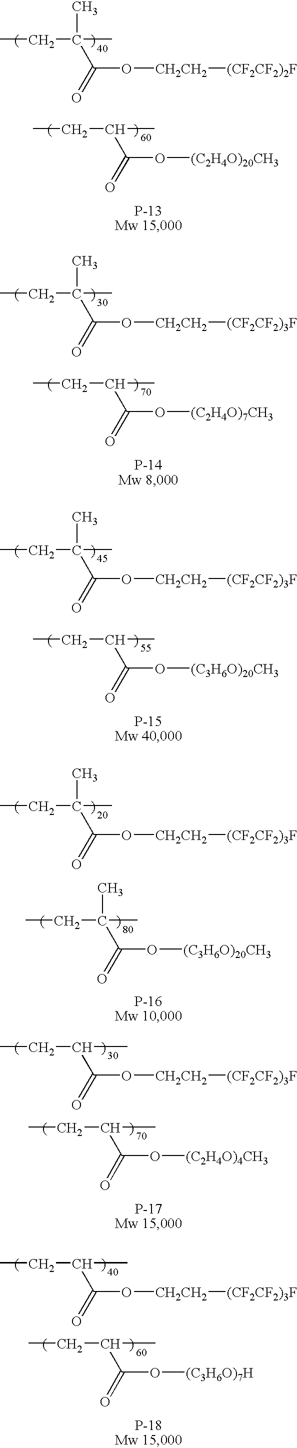

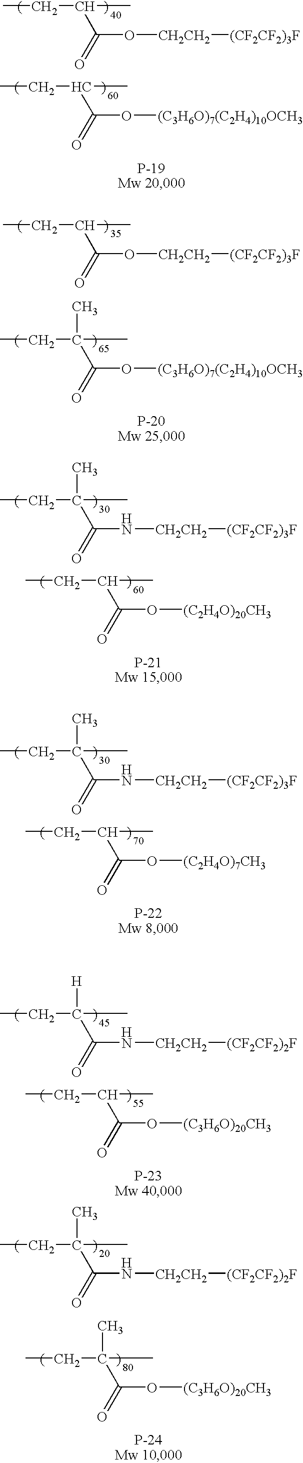

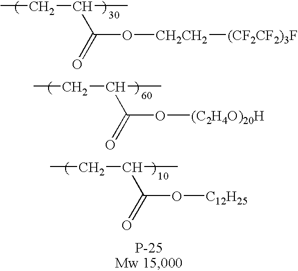

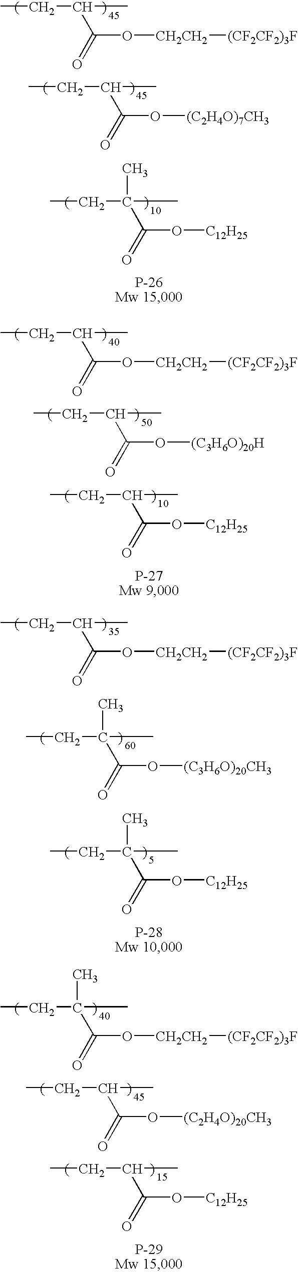

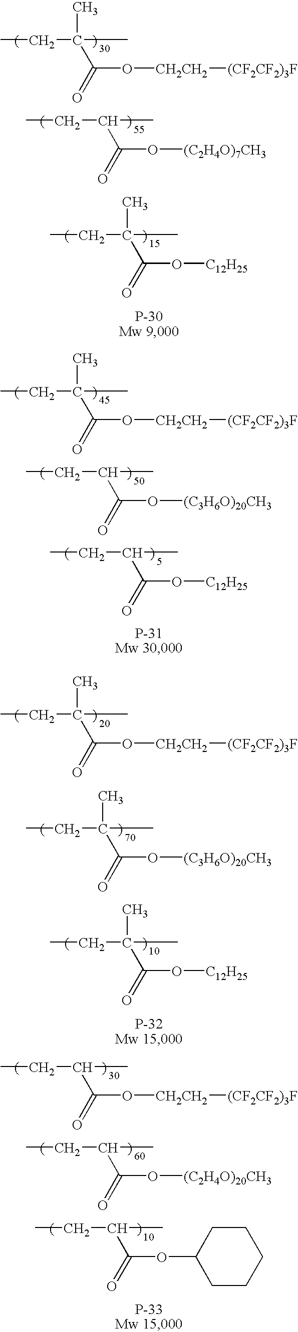

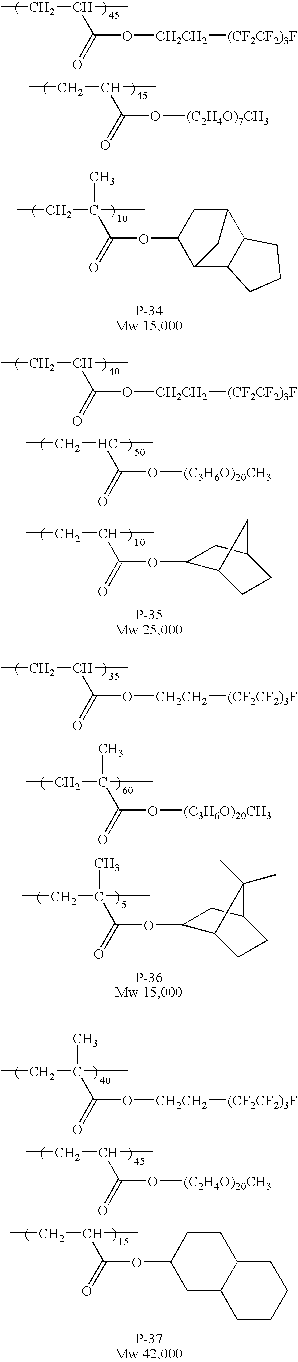

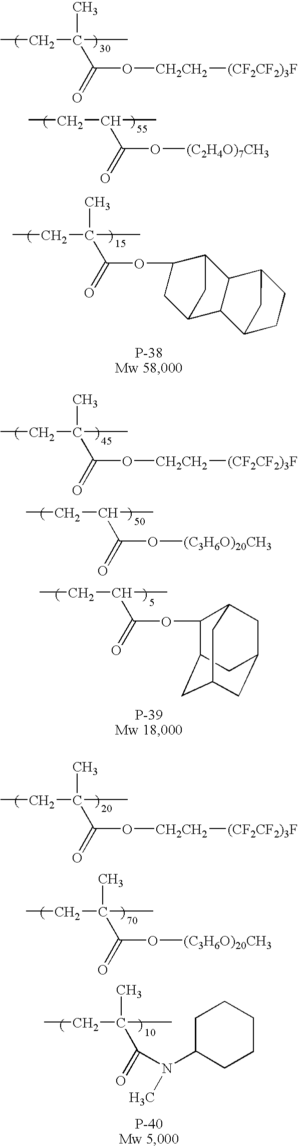

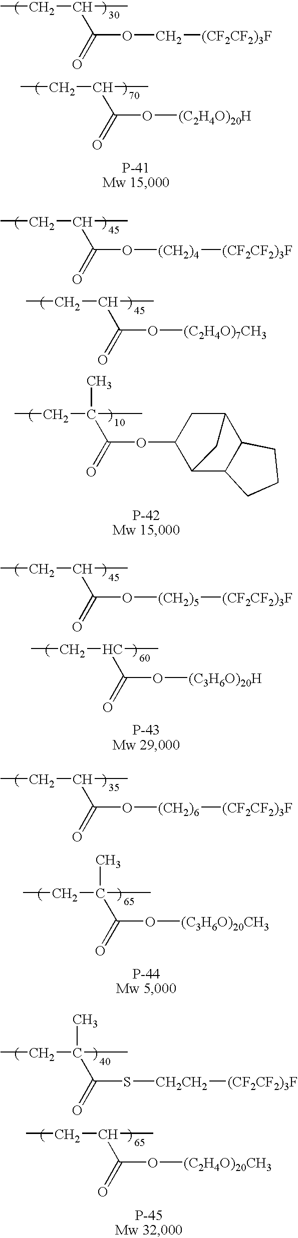

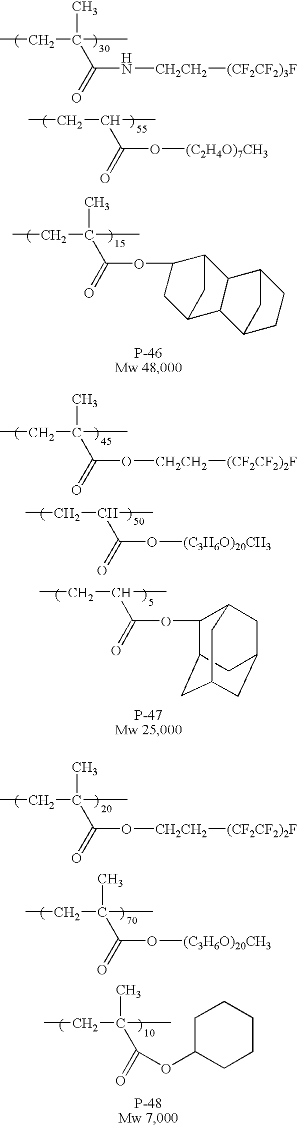

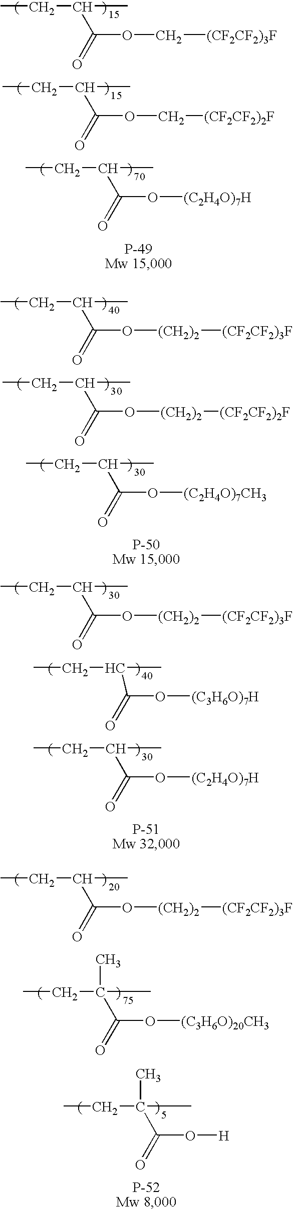

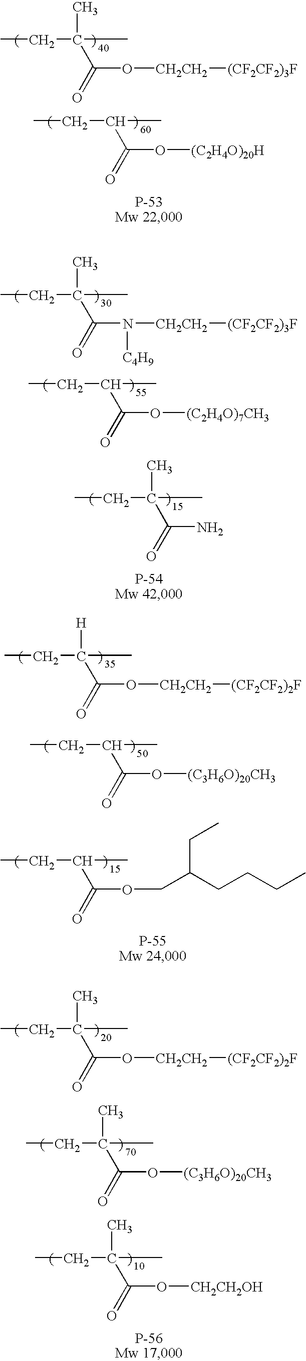

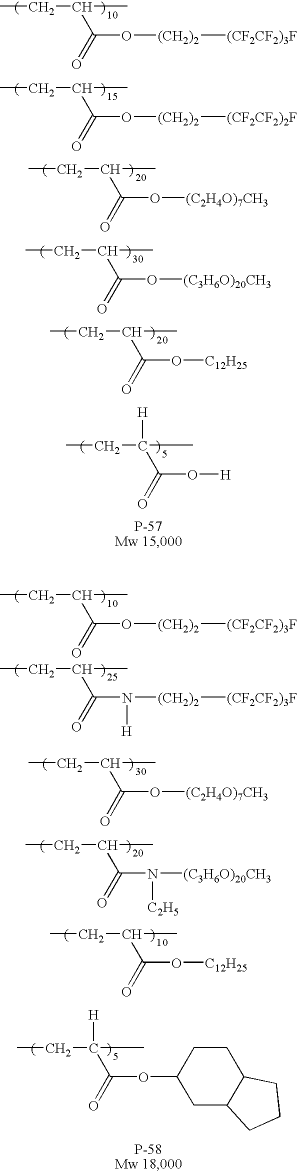

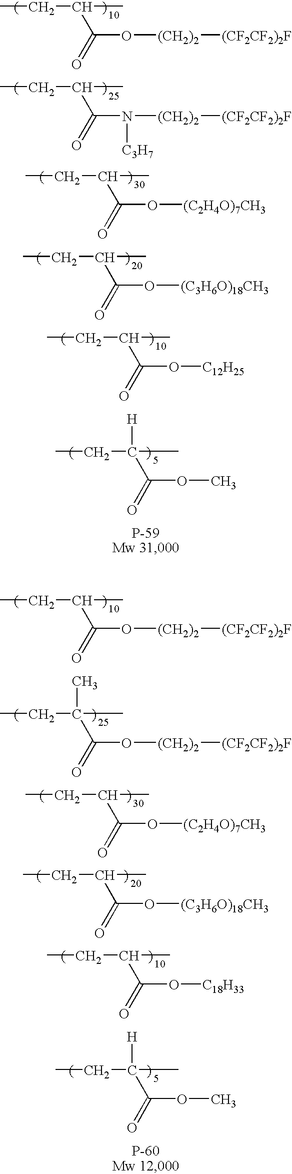

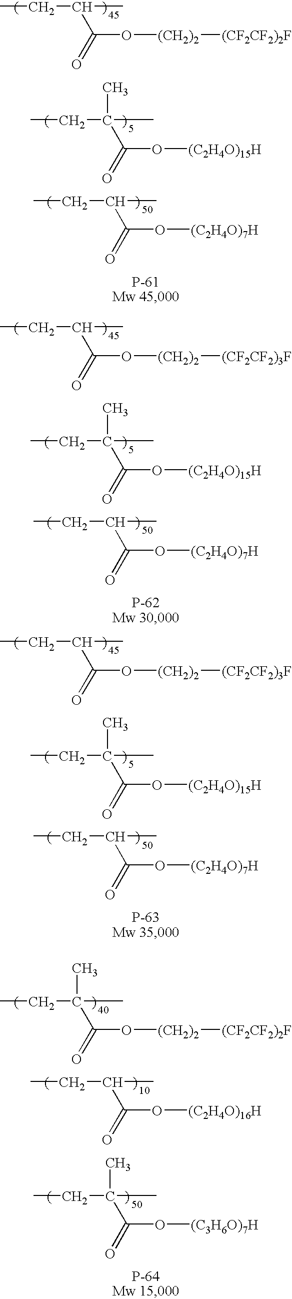

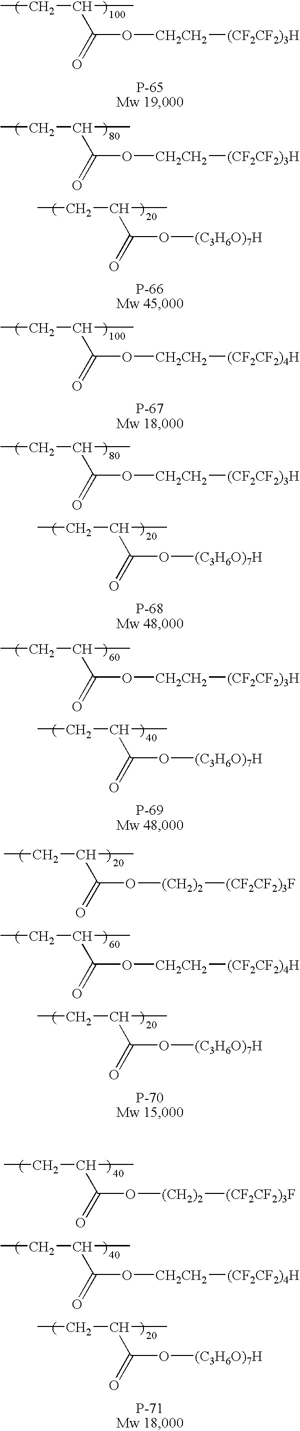

The amount of the surfactant (preferably fluorinated polymer) in the composition (ingredients from which solvent is excluded) to be used for preparing the first optically anisotropic layer is preferably from 0.005 to 8% by mass, more preferably 0.01 to 3% by mass, even more preferably from 0.05 to 1.0% by mass. If the amount is less than 0.005% by mass, the effect may be small; on the other hand, if the amount is more than 8% by mass, drying the film may not be completed fully, or the optical characteristics (for example, uniformity of retardation) of the obtained optical film may be influenced badly.

The liquid crystal compound to be used for preparing the first optciallly anisotropic layer is not limited.

Preferable examples of the liquid crystal compound include rod-like liquid crystal compounds and discotic liquid crystal compounds.

Examples of the rod-like liquid crystal which can be used in the invention include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles. Polymerizable groups may be introduced into the terminal portions of such rod-like liquid crystal compounds (or discotic liquid crystal compounds described hereinafter), and so, by utilizing polymerization or curing-reaction of such polymerizable groups, it is possible to fix the alignment state of liquid crystal molecules. One example, in which polymerization of a polymerizable nematic rod-like liquid crystal compound is carried out under UV light, is described in JP-A-2006-209073. In the invention, the liquid crystal compound can be selected from not only low-molecular weight compounds but also high-molecular weight compounds. Examples of the high-molecular weight liquid crystal compound include polymers having any residue of the low-molecular weight liquid crystal compound(s) in side chain. One example of the optical compensation film prepared by using a high-molecular weight liquid crystal compound is described in JP-A-5-53016.

Examples of discotic liquid-crystalline compounds include benzene derivatives described in “Mol. Cryst.”, vol. 71, page 111 (1981), C. Destrade et al; truxane derivatives described in “Mol. Cryst.”, vol. 122, page 141 (1985), C. Destrade et al. and “Physics lett. A”, vol. 78, page 82 (1990); cyclohexane derivatives described in “Angew. Chem.”, vol. 96, page 70 (1984), B. Kohne et al.; and macrocycles based aza-crowns or phenyl acetylenes described in “J. Chem. Commun.”, page 1794 (1985), M. Lehn et al. and “J. Am. Chem. Soc.”, vol. 116, page 2,655 (1994), J. Zhang et al. The polymerization of discotic liquid-crystalline compounds is described in JP-A-8-27284.

In order to immobilize discotic liquid crystalline molecules by a polymerization, a polymerizable group has to be bonded as a substituent group to a disk-shaped core of the discotic liquid crystalline molecule. In a preferred compound, the disk-shaped core and the polymerizable group are preferably bonded through a linking group, whereby the aligned state can be maintained in the polymerization reaction. Preferred examples of the discotic liquid crystalline compound having a polymerizable group include the group represented by a formula (A) below.

D(-L-P)ₙ (A)

In the formula, D is a disk-shaped core, L is a divalent liking group, P is a polymerizable group and n is an integer from 3 to 12.

Examples of the disk-shaped core D include, but are not limited to, those shown below. In each of the examples, LP or PL means the combination of the divalent linking group (L) and the polymerizable group (P).

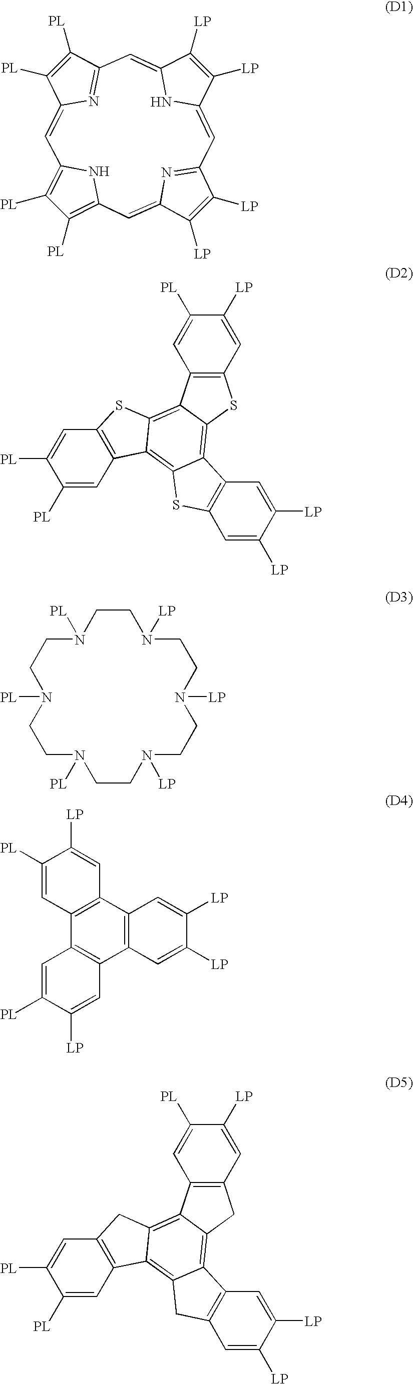

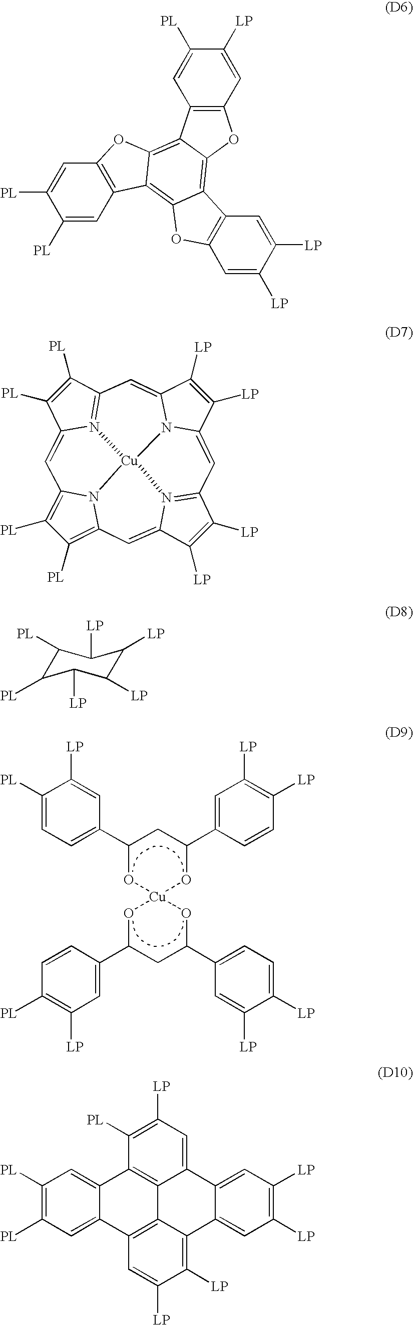

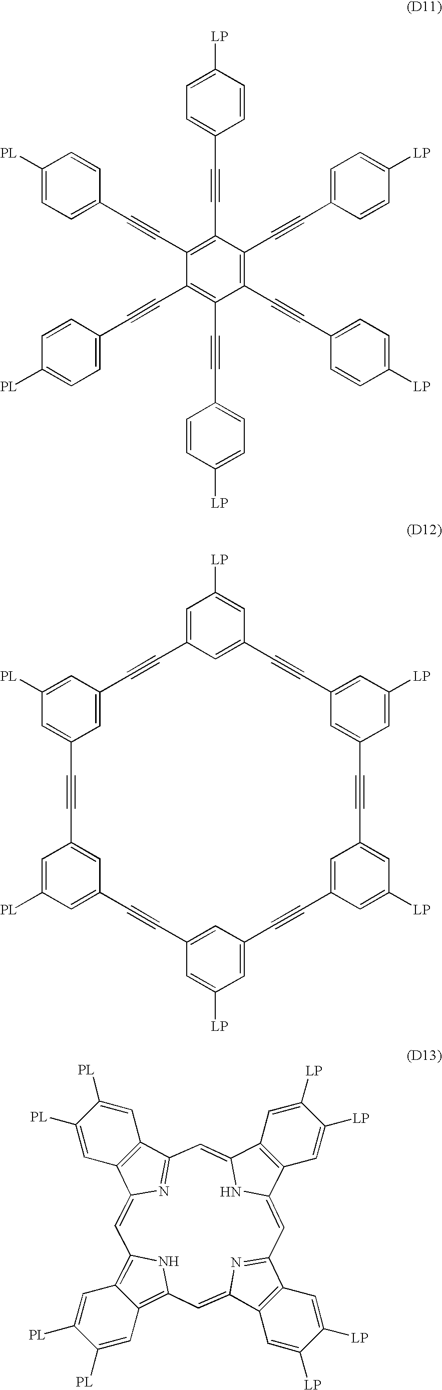

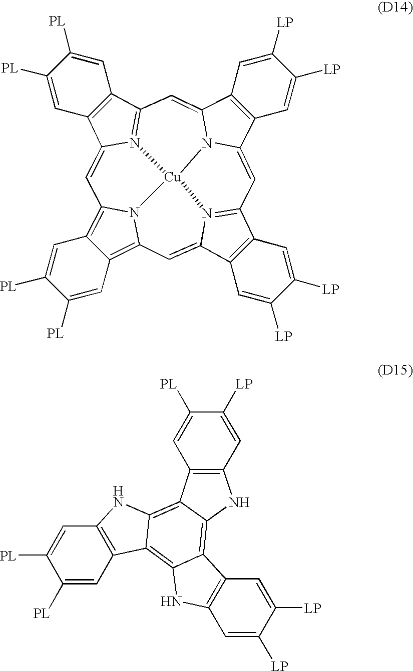

And compounds having a tri-substituted benzene skeleton described in JP-A-2006-76992, [0052], and in JP-A-2007-102205, [0040]-[0063], are preferred since their birefringence exhibits a wavelength dependency similar to that of liquid crystal material to be usually used in a liquid crystal cell. Among those, the benzene skeleton shown below is preferred.

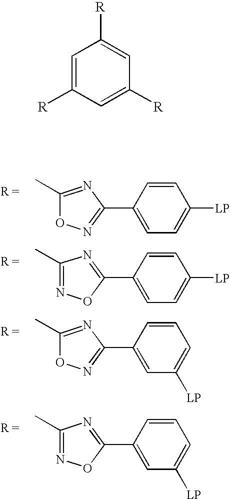

In the formula, preferably, the bivalent linking group L represents a bivalent linking group selected from the group consisting of alkylenes, alkenylenes, arylenes, —CO—, —NH—, —O—, —S— and any combinations thereof. More preferably, the bivalent linking group L represents a bivalent linking group selected from the group consisting of any combinations of two or more selected from alkylenes, arylenes, —CO—, —NH—, —O— and —S—. Even more preferably, the bivalent linking group (L) represents a bivalent linking group selected from the group consisting of any combinations of two or more selected from alkylenes, arylenes, —CO— and —O—. The carbon number of the alkylene may be from 1 to 12, the carbon number of the alkenylene may be from 2 to 12; and the carbon number of the arylene may be from 6 to 10.

Examples of the bivalent group (L) include those shown below. In the formulas, the left terminal portion binds to the discotic core (D) and the right terminal side binds to the polymerizable group (P). in the formulas, “AL” represents an alkylene or an alkenylene; and “AR” represents an arylene. The alkylene, alkenylene or arylene may have at least one substituent such as an alkyl group.

-AL-CO—O-AL- L1

-AL-CO—O-AL-O— L2

-AL-CO—O-AL-O-AL- L3

-AL-CO—O-AL-O—CO- L4

—CO-AR-O-AL- L5

—CO-AR-O-AL-O— L6

—CO-AR-O-AL-O—CO— L7

—CO—NH-AL- L8

—NH-AL-O— L9

—NH-AL-O—CO— L10

—O-AL- L11

—O-AL-O— L12

—O-AL-O—CO— L13

—O-AL-O—CO—NH-AL- L14

—O-AL-S-AL- L15

—O—CO-AR-O-AL-CO— L16

—O—CO-AR-O-AL-O—CO— L17

—O—CO-AR-O-AL-O-AL-O—CO L18

—O—CO-AR-O-AL-O-AL-O-AL-O—CO— L19

—S-AL- L20

—S-AL-O— L21

—S-AL-O—CO— L22

—S-AL-S-AL- L23

—S-AR-AL- L24

In the formula (A), the polymerizable group (P) may be selected depending on the types of polymerization to be employed. Examples of the polymerizable group (P) include those shown below.

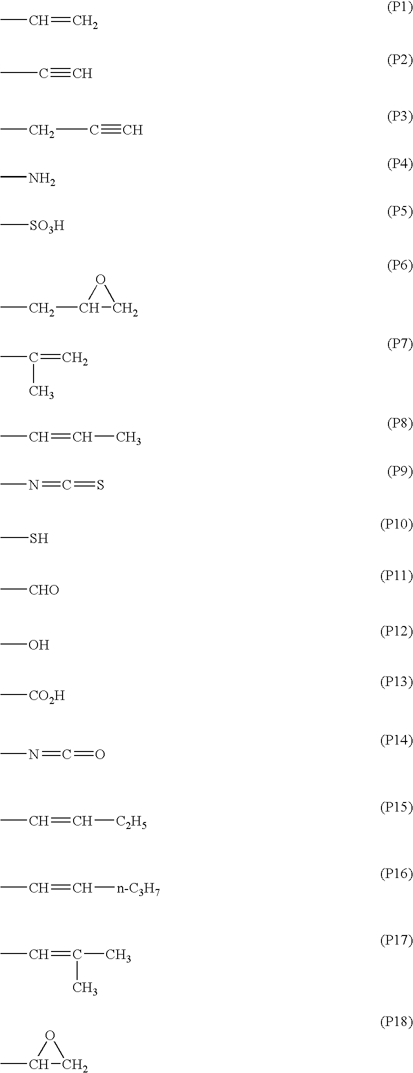

Preferably, the polymerizable group (P) is selected from unsaturated polymerizable groups, P1, P2, P3, P7, P8, P15, P16 and P17, or epoxy groups, P6 and P18. More preferably the polymerizable group is selected from the unsaturated polymerizable groups, and even more preferably it is selected from ethylenic unsaturated polymerizable groups, P1, P7, P8, P15, P16 and P17.

In the formula, n is an integer from 3 to 12, and n may be decided depending on types of discotic core (D) to be employed. In the formula, the plurality of the combination of L and P may be same or different from each other, and preferably the plurality of the combination is same.

The amount of the liquid crystal compound in the composition is preferably from 50 to 99.9 mass %, more preferably from 70 to 99.9 mass % and even more preferably from 80 to 99.5 mass % with respect to the total mass of the composition (if the composition contains any solvent, the amount is with respect to the total mass of the solid content in the composition).

The liquid crystal composition may comprise at least one additive such as plasticizers and polymerizable monomers along with the liquid crystal compound and the fluorinated surfactant. Such additives may be employed for various purposes such as homogenizing the coating film, strengthening the film and improving orientation of liquid crystal molecules. Preferably, the additive to be employed is compatible with the liquid crystal compound and doesn't inhibit the orientation of liquid crystal molecules.

Examples of the polymerizable monomer to be used include radical-polymerizable or cation-polymerizable compounds. Polyfunctional radical-polymerizable monomers are preferred, and among those, the compounds which can co-polymerize with the liquid crystal compound having a polymerizable group(s). Examples of such a compound include those described in the paragraphs [0018] to [0020] of JP-A-2002-296423. The amount of the compound is preferably from 1 to 50 mass % and more preferably from 5 to 30 mass % with respect to the amount of the liquid crystal compound.

The polymer to be used along with the liquid crystal compound may be selected from the polymers capable of increasing viscosity of coating liquid. Examples of such polymer include cellulose esters. Preferred examples of cellulose ester include those in the paragraph [0178] of JP-A-2000-155216. Avoiding inhibition of orientation of liquid crystal molecules, preferably, the amount of the polymer is from 0.1 to 10 mass % and more preferably from 0.1 to 8 mass % with respect to the amount of the liquid crystal compound.

The first optically anisotropic layer may be prepared according to a method comprising applying the liquid crystal composition to a surface (for example rubbed surface), aligning liquid crystal molecules in it at a temperature equal to or less than the transition point between the liquid crystal and solid phases, and then irradiating it with UV light for carrying out polymerization of the molecules and for immobilizing them in the alignment state. The coating method may be any known method of bar-coating, extrusion-coating, direct gravure-coating, reverse gravure-coating or die-coating. The transition point between the liquid crystal and the solid phases maybe from 70 to 300 degree C., or may be from 70 to 170 degree C. The polymerization of liquid crystal compound may be carried out according to a photo-polymerization process. The layer is irradiated with UV light to carry out polymerization reaction, and the irradiation energy is preferably from 20 mJ/cm² to 5000 mJ/cm², more preferably from 100 mJ/cm² to 800 mJ/cm². For promoting the optical polymerization, the light irradiation may be attained under heat. Avoiding inhibition of orientation of the liquid crystal molecules, heat may be performed so as to be a temperature equal to or less than 120 degree C.

One example of preparing the first optically anisotropic layer is as follows. A composition, containing at least one liquid crystal compound, is applied to a surface of a polymer film to be used as the second optically anisotropic layer (or a surface of an alignment layer disposed on the polymer film); molecules of the liquid crystal compound are aligned in a desired alignment state; and then the alignment state is fixed via polymerization of the composition. Preferably, the first optically anisotropic layer has no direction in which retardation at a wavelength of 550 nm is 0 nm, and has no direction neither in-plane nor in the normal line direction in which the absolute value of retardation at a wavelength of 550 nm is minimum. For preparing the layer having such optical properties, molecules of the rod-like or discotic liquid crystal compound are preferably fixed in a hybrid alignment state.

It is to be noted that the term “hybrid alignment” means an alignment state in which liquid crystal molecules are aligned so that the directions of their directors are varied along the thickness direction continuously

For preparing the first optically anisotropic layer, any alignment layer formed of polyvinyl alcohol or the like is preferably used.

The thickness of the first optically anisotropic layer may be from 0.5 to 100 μm or from 0.5 to 30 μm.

In the above, examples wherein the surface roughness of the first optically anisotropic layer is adjusted by using a fluorinated surfactant having a poly(alkylene oxy) group are explained. However, the surface roughness of the optically anisotropic layer may be adjusted by controlling the conditions such as a temperature or time in the step for aligning liquid crystal molecules.

### 1.-2 Second Optically Anisotropic Layer

According to the invention, the second optically anisotropic layer comprises at least one selected from cycloolefin-base homopolymers and copolymers (the terms “cycloolefin-base polymer” is used for indicating both), preferably as the main ingredient thereof (in an amount of at least 50% by mass of all ingredients). The cycloolefin-base polymer film has a high friction coefficient, and therefore, the dynamic friction coefficient between the two sides of the optical film tends to be high when the cycloolefin-base polymer film constructs either of the two sides of the optical film. For achieving the dynamic friction coefficient of 1.0 or smaller, preferably, fine particles are added to the second optically anisotropic layer. Examples of the fine particles which can be used in the invention are described later.

Examples of cycloolefin-base homopolymers and copolymers usable in production of the second optically anisotropic layer include ring-opened polymers of polycyclic monomers, etc. Specific examples of polycyclic monomers are the following compounds, to which, however, the invention should not be limited.
bicyclo[2.2.1]hept-2-ene,
tricyclo[4.3.0.1^{2,5})-8-decene,
tricyclo[4.4.0.1^{2,5})-3-undecene,
tetracyclo[4.4.0.1^{2,5}.1^{7,10}]-3-dodecene,
pentacyclo[6.5.1.1^{3,6}.0^{2,7}.0^{9,13}]-4-pentadecene,
5-methylbicyclo[2.2.1]hept-2-ene,
5-ethylbicyclo[2.2.1]hept-2-ene,
5-methoxycarbonylbicyclo[2.2.1]hept-2-ene,
5-methyl-5-methoxycarbonylbicyclo[2.2.1]hept-2-ene,
5-cyanobicyclo[2.2.1]hept-2-ene,
8-methoxycarbonyltetracyclo[4.4.0.1^{2,5}.1^{7,10}]-3-dodecene,
8-ethoxycarbonyltetracyclo[4.4.0.1^{2,5}.1^{7,10}]-3-dodecene,
8-n-propoxycarbonyltetracyclo[4.4.0.1^{2,5}.1^{7,10}]-3-dodecene,
8-isopropoxycarbonyltetracyclo[4.4.0.1^{2,5}.1^{7,10}]-3-dodecene,
8-n-butoxycarbonyltetracyclo[4.4.0.1^{2,5}.1^{7,10}]-3-dodecene,
8-methyl-8-methoxycarbonyltetracyclo[4.4.0.1^{2,5}.1^{7,10}]-3-dodecene,
8-methyl-8-ethoxycarbonyltetracyclo[4.4.0.1^{2,5}.1^{7,10}]-3-dodecene,
8-methyl-8-n-propoxycarbonyltetracyclo[4.4.0.1^{2,5}.1^{7,10}]-3-dodecene,
8-methyl-8-isopropoxycarbonyltetracyclo[4.4.0.1^{2,5}.1^{7,10}]-3-dodecene,
8-methyl-8-n-butoxycarbonyltetracyclo[4.4.0.1^{2,5}.1^{7,10}]-3-dodecene,
5-ethylidenebicyclo[2.2.1]kept-2-ene,
8-ethylidenetetracyclo[4.4.0.1^{2,5}.1^{7,10}]-3-dodecene,
5-phenylbicyclo[2.2.1]-hept-2-ene,
8-phenyltetracyclo[4.4.0.1^{2,5}.1^{7,10}]-3-dodecene,
5-fluorobicyclo[2.2.1]hept-2-ene,
5-fluoromethylbicyclo[2.2.1]hept-2-ene,
5-trifluoromethylbicyclo[2.2.1]hept-2-ene,
5-pentafluoroethylbicyclo[2.2.1]hept-2-ene,
5,5-difluorobicyclo[2.2.1]hept-2-ene,
5,6-difluorobicyclo[2.2.1]hept-2-ene,
5,5-bis(trifluoromethyl)bicyclo[2.2.1]hept-2-ene,
5,6-bis(trifluoromethyl)bicyclo[2.2.1]hept-2-ene,
5-methyl-5-trifluoromethylbicyclo[2.2.1]hept-2-ene,
5,5,6-trifluorobicyclo[2.2.1]hept-2-ene,
5,5,6-tris(fluoromethyl)bicyclo[2.2.1]hept-2-ene,
5,5,6,6-tetrafluorobicyclo[2.2.1]hept-2-ene,
5,5,6,6-tetrakis(trifluoromethyl)bicyclo[2.2.1]hept-2-ene,
5,5-difluoro-6,6-bis(trifluoromethyl)bicyclo[2.2.1]hept-2-ene,
5,6-difluoro-5,6-bis(trifluoromethyl)bicyclo[2.2.1]hept-2-ene,
5,5,6-trifluoro-5-trifluoromethylbicyclo[2.2.1]kept-2-ene,
5-fluoro-5-pentafluoroethyl-6,6-bis(trifluoromethyl)bicyclo[2.2.1]hept-2-ene,
5,6-difluoro-5-heptafluoro-iso-propyl-6-trifluoromethylbicyclo[2.2.1]hept-2-ene,
5-chloro-5,6,6-trifluorobicyclo[2.2.1]hept-2-ene,
5,6-dichloro-5,6-bis(trifluoromethyl)bicyclo[2.2.1]hept-2-ene,
5,5,6-trifluoro-6-trifluoromethoxybicyclo[2.2.1]hept-2-ene,
5,5,6-trifluoro-6-heptafluoropropoxybicyclo[2.2.1]hept-2-ene,
8-fluorotetracyclo[4.4.0.1^{2,5}.1^{7,10}]-3-dodecene,
8-fluoromethyltetracyclo[4.4.0.1^{2,5}.1^{7,10}]-3-dodecene,
8-difluoromethyltetracyclo[4.4.0.1^{2,5}.1^{7,10}]-3-dodecene,
8-trifluoromethyltetracyclo[4.4.0.1^{2,5}.1^{7,10}]-3-dodecene,
8-pentafluoroethyltetracyclo[4.4.0.1^{2,5}.1^{7,10}]-3-dodecene,
8,8-difluorotetracyclo[4.4.0.1^{2,5}.1^{7,10}]-3-dodecene,
8,9-difluorotetracyclo[4.4.0.1^{2,5}.1^{7,10}]-3-dodecene,
8,8-bis(trifluoromethyptetracyclo[4.4.0.1^{2,5}.1^{7,10}]-3-dodecene,
8,9-bis(trifluoromethyptetracyclo[4.4.0.1^{2,5}.1^{7,10}]-3-dodecene,
8-methyl-8-trifluoromethyltetracyclo[4.4.0.1^{2,5}.1^{7,10}]-3-dodecene,
8,8,9-trifluorotetracyclo[4.4.0.1^{2,5}.1^{7,10}]-3-dodecene,
8,8,9-tris(trifluoromethyl)tetracyclo[4.4.0.1^{2,5}.1^{7,10}]-3-dodecene,
8,8,9,9-tetrafluorotetracyclo[4.4.0.1^{2,5}.1^{7,10}]-3-dodecene,
8,8,9,9-tetrakis(trifluoromethyptetracyclo[4.4.0.1^{2,5}.1^{7,10}]-3-dodecene,
8,8-difluoro-9,9-bis(trifluoromethyptetracyclo[4.4.0.1^{2,5}.1^{7,10}]-3-dodecene,
8,9-difluoro-8,9-bis(trifluoromethyptetracyclo[4.4.0.1^{2,5}.1^{7,10}]-3-dodecene,
8,8,9-trifluoro-9-trifluoromethyltetracyclo[4.4.0.1^{2,5}.1^{7,10}]-3-dodecene,
8,8,9-trifluoro-9-trifluoromethoxytetracyclo[4.4.0.1^{2,5}.1^{7,10}]-3-dodecene,
8,8,9-trifluoro-9-pentafluoropropoxytetracyclo[4.4.0.1^{2,5}.1^{7,10}]-3-dodecene,
8-fluoro-8-pentafluoroethyl-9,9-bis(trifluoromethyptetracyclo[4.4.0.1^{2,5}.1^{7,10}]-3-dodecene,
8,9-difluoro-8-pentafluoro-isopropyl-9-trifluoromethyltetracyclo[4.4.0.1^{2,5}.1^{7,10}]-3-dodecene,
8-chloro-8,9,9-trifluorotetracyclo[4.4.0.1^{2,5}.1^{7,10}]-3-dodecene,
8,9-dichloro-8,9-bis(trifluoromethyl)tetracyclo[4.4.0.1^{2,5}.1^{7,10}]-3-dodecene,
8-(2,2,2-trifluoroethoxycarbonyl)tetracyclo[4.4.0.1^{2,5}.1^{7,10}]-3-dodecene,
8-methyl-8-(2,2,2-trifluoroethoxycarbonyl)tetracyclo[4.4.0.1^{2,5}.1^{7,10}]-3-dodecene.

One or more of these may be used, either singly or as combined.

Not specifically defined, the molecular weight of those compounds is, in general, preferably from 5000 to 500000, more preferably from 10000 to 100000. As commercially-available cycloolefin-base polymers, ARTON series (by JSR), ZEONOR series (by Nippon Zeon), ZEONEX series (by Nippon Zeon) and ESSINA (by Sekisui Chemical Industry) are usable. Commercially available polymer films may be used after they are subjected to a stretching treatment so as to have the optical characteristics satisfying the above-mentioned numerical relations. For example, when ZEONOR series polymer films are used, they may be stretched in the machine direction (in the lengthwise direction of films) and/or in the cross direction (in the widthwise direction of films), thereby to be polymer films capable of satisfying the optical characteristics required for the support. Preferably, the stretching ratio in machine-direction is from 1 to 150%, and more preferably from 1 to 50%; and, preferably, the stretching ratio in cross-direction is from 2 to 200%, and more preferably from 5 to 100%.

The second optically anisotropic layer may be a self-supportable cycloolefin-base polymer film. The second optically anisotropic layer may be a polymer layer disposed on a support. However, the second optically anisotropic layer is preferably a self-supportable cycloolefin-base polymer film. The production method for the polymer films for the second optically anisotropic layer is not specifically defined, and polymer films produced in various methods may be used. For example, the polymer films may be those produced by any method of melt casting or solution casting. Conditions in film formation are described in detail in JP-A-2004-198952, and the description may be referred to in producing the films in the invention.

One example of a method for preparing the cycloolefin-base polymer films to be used as the second optically anisotropic layer is as follows. After films are produced according to a solution casting method, they are stretched in the machine direction and the cross direction of the films. Preferably, the stretching ratio in the machine direction is from about 1 to about 200%, more preferably from about 1 to about 150% and even more preferably from about 1 to about 50%. Preferably, the stretching ratio in the cross direction is from about 2 to about 200%, and more preferably from about 5 to about 100%. The stretching in the machine direction may be attained by the difference in the rotation of rolls that support the film; and the stretching in the cross direction may be attained by the use of a tenter.

The polymer films for use as the second optically anisotropic layer may contain one or more additives in addition to the cycloolefin-base homopolymer or copolymer.

As mentioned above, the second optically anisotropic layer preferably contains fine particles as a mat agent. Fine particles which have usually used are usable as a mat agent, and are not limited. Plural types of fine particles may be used. Fine particles of any inorganic compound or fine particles of any polymer may be used.

Examples of the fine particles of inorganic compound include fine particles of barium sulfate, manganese colloid, titanium dioxide, strontium barium sulfate, and silicon dioxide. Fine particles of silicon dioxide, or that is, synthetic silica, prepared according to a wet process or a gel process of hydrated silica and fine particles of rutile- or anatase-type titanium dioxide made from titanium slug and sulfuric acid may be also used. Inorganic compounds having a particle size of 20 μm or more may be also used after being subjected to a classification such as air classification and vibration-filtration. Among fine particles of inorganic compounds, fine particles containing silicon are preferable in terms of lowering turbidity and haze of the film. Fine particles of inorganic compound subjected to a surface treatment with any organic material are preferable in terms of lowering haze of the film. Examples of the organic material to be used in the surface treatment include halosilanes, alkoxysilanes, silazanes and siloxanes.

Examples of the fine particles of organic compound include fine particles of polytetrafluoroethylene, cellulose acetate, polystyrene, polymethylmethacrylate, polypropylmethacrylate, polymethylacrylate, polyethylene carbonate, and starch. They may be used after being subjected to a classification. Polymer fine particles prepared according to a suspension polymerization, and fine particles of polymer or inorganic compound subjected to a spheronization treatment according to a spray dry or dispersion process may be also used.

One or more types of polymers of any monomer(s) describe below may be subjected to any microparticulation, and then may be used in the invention. Examples of the monomer are as follows.

Examples include acrylates, methacrylates, dialkyl itaconates, crotonates, dialkyl maleates and phthalates; and examples of the ester residue thereof include methyl, ethyl, propyl, isopropyl, butyl, hexyl, 2-ethyl hexyl, 2-chloro ethyl, cyano ethyl, 2-acetoxy ethyl, dimethyl amino ethyl, benzyl, cyclohexyl, furfuryl, phenyl, 2-hydroxy ethyl, 2-ethoxy ethyl, glycidyl, and w-methoxy polyethylene glycol (additional number of moles is 9).

Examples of the monomer also include vinyl esters such as vinyl acetate, vinyl propionate, vinyl butyrate, vinyl isobutyrate, vinyl caproate, vinyl chloro acetate, vinyl methoxy acetate, vinyl phenyl acetate, vinyl benzoate and vinyl salicylate; olefins such as dicyclopentadiene, ethylene, propylene, 1-butene, 1-pentene, vinyl chloride, vinylidene chloride, isoprene, chloroprene, butadiene and 2,3-dimethyl butadiene; styrenes such as styrene, methyl styrene, dimethyl styrene, trimethyl styrene, ethyl styrene, isopropyl styrene, chloromethyl styrene, methoxy styrene, acetoxy styrene, chlorostyrene, dichlorostyrene, bromestyrene, trifluoromethyl styrene and vinyl methyl benzoate; acrylamide such as acrylamide, methyl acrylamide, ethyl acrylamide, propyl acrylamide, butyl acrylamide, tert-butyl acrylamide, phenyl acrylamide and dimethyl acrylamide; methacrylamides such as methacrylamide, methyl methacrylamide, ethyl methacrylamide, propyl methacrylamide and tert-butyl methacrylamide; allyl compounds such as allyl acetate, allyl caproate, allyl laurate and allyl benzoate; vinyl ethers such as methyl vinyl ether, butyl vinyl ether, hexyl vinyl ether, methoxy ethyl vinyl ether and dimethyl amino ethyl vinyl ether; vinyl ketones such as methyl vinyl ketone, phenyl vinyl ketone and methoxyethyl vinyl ketone; vinyl heterocyclic compounds such as vinyl pyridine, N-vinyl imidazole, N-vinyl oxazoline, N-vinyl triazole and N-vinyl pyrolidone; unsaturated nitriles such as acryl nitrile and methacryl nitrile; multifunctional monomers such as divinyl benzene, methylene bisacrylamide, and ethylene glycol dimethacrylate.

Examples of the monomer also include acrylic acid, methacrylic acid, itaconic acid, maleic acid, monoalkyl itaconate such as monoethyl itaconates; monoalkyl maleates such as monomethyl maleate; styrenesulfonic acid, vinyl benzylsulfonic acid, vinylsulfonic acid, acryloyloxy alkylsulfonic acid such as acryloyloxy methylsulfonic acid; methacryloyloxy alkylsulfonic acid such as methacryloyloxy ethylsulfonic acid; acrylamide alkylsulfonic acid such as 2-acrylamide-2-methylethanesulfonic acid; methacrylamide alkylsulfonic acid such as 2-methacrylamide-2-methylethanesulfonic acid; and acryloyloxy alkylphosphate such as acryloyloxy ethylphosphate. These acids may form salts with any alkali metal such as Na and K or ammonium ion. Examples of the monomer also include crosslinkable monomers described in U.S. Pat. Nos. 3,459,790, 3,438,708, 3,554,987, 4,215,195 and 4,247,673; or JP-A-57-205735. Examples of the crosslinkable monomer include N-(2-acetoacetoxyethyl)acrylamide and N-(2-(2-acetoacetoxyethoxy)ethyl)acrylamide.

Fine particles of the homopolymer of the monomer or copolymer of plural monomers may be used. Among the examples, acrylates, methacryalates, vinyl esters, styrenes and olefins are preferable. Fine particles having a fluorine atom or silicon atom described in JP-A-62-14647, JP-A-62-17744 and JP-A-62-17743 may be used.

Preferable examples of the polymer include polystyrene, polymethyl(meth)acrylate, polyethylene acrylate, poly(methylmethacrylate/Methacrylic acid=95/5 (molar ratio)), poly(styrene/styrenesulfonic acid=95/5 (molar ratio)), polyacrylnitrile, poly(methyl methacrylate/ethyl acrylate/methacrylic acid=50/40/10) and silica.

Examples of the fine particles which can be used in the invention include fine particles having a reactive group such as gelatin described in JP-A-64-77052 and European Patent No, 307,855; and fine particles having an alkaline group or acidic group by a large amount. Examples of the fine particles which can be used in the invention include, but are not limited to, those shown below.

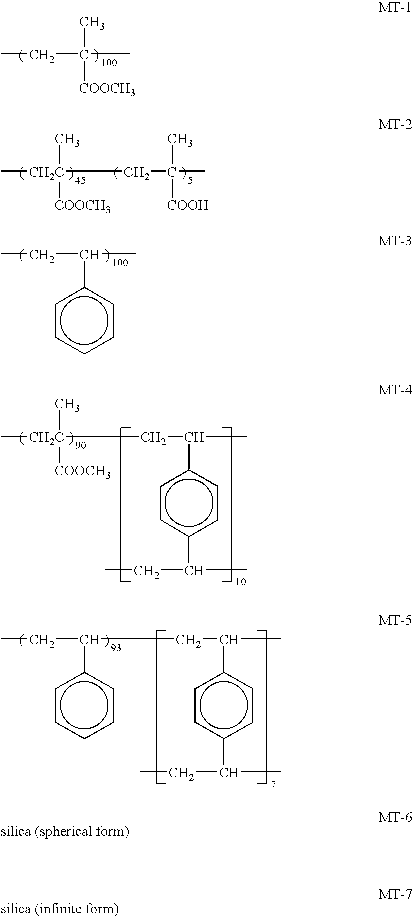

The particle diameter of the fine particles to be used in the invention is not limited. For avoiding the drastic increase of haze and improving the slip property, generally, using fine particles having the mean primary particle diameter of from 10⁻³ to 10 μm is preferable; using fine particles having the mean primary particle diameter of from 10⁻³ to 5 μm is more preferable; using fine particles having the mean primary particle diameter of from 0.005 to 3 μm is even more preferable; and using fine particles having the mean primary particle diameter of from 0.01 to 1 μm is even much more preferable.

In the embodiments wherein the second optically anisotropic layer is a cycloolefin base polymer film containing fine particles, |Δn|, which is the absolute value of the difference in refractive index between the cycloolefin base polymer and fine particles, and r (μm), which is a mean particle diameter, preferably meet the relation of “|Δn|·r≦0.05 (μm)”. Adding fine particles to a film may increase haze of the film. However, when the relation is satisfied, adding fine particles to a film may contribute to improving the slip property without causing much increase of haze thereof. From the same viewpoint, |Δn|·r is preferably equal to or smaller than 0.03 μm, and more preferably equal to or smaller than 0.015 μm.

In the embodiments wherein the second optically anisotropic layer is a cycloolefin base polymer film, the process of preparing the polymer film is not limited. Any polymer films prepared according to a solvent casting method or melt casting method may be used. Fine particles may be added to the cycloolefin base polymer film according to any method. One example of the method of preparing a cycloolefin base polymer film containing fine particles may contain steps as follows:

a step of preparing a fine-particle dispersion liquid containing organic solvent, fine particles and at least one cycloolefin base homopolymer or copolymer (the term “cycloolefin base polymer” indicating both is used hereinafter);

a step of preparing a cycloolefin base polymer solution containing an organic solvent and at least one cycloolefin base polymer;

a step of preparing a dope by mixing the fine-particle dispersion liquid and the cycloolefin base polymer solution: and

a step of casting the dope to a surface to form a film.

The method is described in detail in JP-A-2007-77243 and JP-A-2005-103815.

In preparing the second optically anisotropic layer, any co-casting method may be used. According to any co-casting method, cycloolefin base polymer in which fine particles are dispersed and cycloolefin base polymer in which no fine particles are dispersed may be cast on a surface simultaneously, and therefore, the second optically anisotropic layer whose slip property is improved can be prepared without causing much increase of haze thereof.

One possible embodiment has the outer layer containing fine particles and the inner layer containing no fine particles; and in such an embodiment, the thickness of the outer layer is preferably equal to or less than 10 μm, more preferably equal to or less than 8 μm, and much more preferably equal to or less than 5 μm.

In the embodiment wherein the cycloolefin base polymer is cast alone, the outer layer, containing fine particles, is preferably formed on both sides of the inner layer.

In the embodiments wherein the first optically anisotropic layer is formed on the film without being subjected to a wind-up treatment after casting the cycloolefin base polymer, the outer layer, containing fine particles, is preferably formed only on one side, on which the first optically anisotropic layer is not formed, of the second optically anisotropic layer.

The cycloolefin base polymer film to be used as the second optically anisotropic layer is preferably subjected to a surface treatment, in the embodiments wherein the film is bonded with the first optically anisotropic layer (or the alignment layer disposed therebetween) or a polarizing film. Examples of the surface treatment include corona discharge treatment, glow discharge treatment, flame treatment, acid treatment, alkali treatment and UV irradiation treatment. Forming a undercoat layer is also preferable.

### 2. Polarizing Plate

The invention also relates to a polarizing plate that comprises at least the above-mentioned optical film of the invention and a polarizing film. When the polarizing plate of the invention is incorporated in a liquid-crystal display device, it is desirable that the optical film is on the side of the liquid-crystal cell. Also preferably, the surface of the second optically anisotropic layer, which is preferably a cycloolefin base polymer film, is stuck to the surface of the polarizing film. Preferably, a protective film such as a cellulose acylate film is stuck to the other face of the polarizing film.

### 2-1 Polarizing Film:

Examples of a polarizing film include an iodine-base polarizing film, a dye-base polarizing film with a dichroic dye, and a polyene-base polarizing film, and any of these is usable in the invention. The iodine-base polarizing film and the dye-base polarizing film are produced generally by the use of polyvinyl alcohol films.

### 2-2 Protective Film:

As the protective film to be stuck to the other surface of the polarizing film, preferably used is a transparent polymer film. “Transparent” means that the film has a light transmittance of at least 80%. As the protective film, preferred are cellulose acylate films and polyolefin films. Of cellulose acylate films, preferred are cellulose triacetate film. Of polyolefin films, preferred are cyclic polyolefin-containing polynorbornene films.

Preferably, the thickness of the protective film is from 20 to 500 μm, more preferably from 30 to 200 μm.

### 2.-3 Method of Preparing Long Polarizing Plate

The polarizing plate of the invention may be produced as a long continuous film. For example, using a long continuous cycloolefin-base polymer film as the transparent support, an alignment film-forming coating liquid is optionally applied onto its surface to form an alignment film thereon, and then a first optically-anisotropic layer-forming coating liquid is continuously applied onto it and dried to form a first optically-anisotropic layer in a desired alignment state, and thereafter this is irradiated with light to thereby fix the alignment state of the layer; and the thus-produced, long continuous optical film is winded up as a roll. Apart from it, a long continuous polarizing film, and a long continuous polymer film for a protective film are separately winded up each as a roll, and they are stuck together in a roll-to-roll mode to complete a long continuous polarizing plate. For example, after winded up as a roll, the long continuous polarizing plate may be transferred and stored in the form of the roll thereof; and before it is incorporated into a liquid-crystal display device, it may be cut into pieces having a desired size.

### 3. Liquid-Crystal Display Device:

The optical film and the polarizing plate of the invention may be used in various types of liquid-crystal display devices. In addition, they may also be used in any of transmission-type, reflection-type and semitransmission-type liquid-crystal display devices. Above all, they are favorable to TN-mode liquid-crystal display devices. One embodiment of the liquid-crystal display device of the invention comprises a pair of the above-mentioned polarizing plates and a liquid-crystal cell disposed between them.

### EXAMPLES

The invention is described more concretely with reference to the following Examples, in which the material and the reagent used, their amount and the ratio, the details of the treatment and the treatment process may be suitably modified or changed not overstepping the sprit and the scope of the invention. Accordingly, the invention should not be limited by the Examples mentioned below. The term “parts” indicates parts by mass hereinunder as far as there is no notation.

### 1. Preparation of Polymer Films to be Used as Second Optically Anisotropic Layer

### (1) Synthetic Example of Cycloolefin Base Polymer A

To a reactor purged with nitrogen, 400 parts of 8-methyl-8-methoxycarbonitriletetracyclo[4.4.0.1^{2.5},1^{7.10}]-3-dodecene, 100 parts of 5-(4-biphenylcarbonyloxy)bicycle[2.2.1]hepto-2-ene, 36 parts of 1-hexene, and 1500 parts of toluene were fed, and the mixture was heated to 60 degrees Celsius. Subsequently, to the solution in the reactor, 1.24 parts of toluene solution of triethylaluminum (1.5 mol/l), and 7.4 parts of toluene solution (concentration 0.05 mol/l) of tungsten hexachloride (t-butanol:methanol:tungsten=0.35 mol:0.3 mol:1 mol) modified by t-butanol and methanol, were added as a polymerization catalyst, the system was heated and stirred at 80 degrees Celsius for 3 hours, thereby subjecting to the ring-opening polymerization reaction to obtain the ring-opened polymer solution.

Next, 4,000 parts of thus obtained ring-opening polymerization solution was fed to an autoclave, to the ring-opened polymer solution, 0.48 parts of RuHCl(CO)[P(C₆H₅)₃]₃ was added, the solution was heated and stirred for 3 hours, under the conditions of a hydrogen gas pressure of 100 kg/cm², a reacting temperature of 165 degrees Celsius, to carry out a hydrogenated reaction.

The obtained reacting solution (hydrogenated polymer solution) was cooled, and then the hydrogen gas was discharged. The reacting solution was poured onto a large amount of methanol, and the aggregate was separated and recovered, and dried, to obtain a hydrogenated polymer (Cycloolefin base polymer A).

### (2) Preparation of Dope A

Dope A was prepared by mixing 30 parts of Cycloolefin base polymer A and 70 parts of toluene.

### (3) Preparation of Dope B

Dope B was prepared by mixing 29.7 parts of Cycloolefin base polymer A, 0.3 parts of commercially available fine particles “AEROSIL R972” (produced by JAPAN AEROSIL) and 70 parts of toluene.

### (4) Preparation of Dope C

Dope C was prepared by mixing 29.85 parts of Cycloolefin base polymer A, 0.15 parts of commercially available fine particles “AEROSIL R972” (produced by JAPAN AEROSIL) and 70 parts of toluene.

### (5) Preparation of Dope D

Dope D was prepared by mixing 29.7 parts of Cycloolefin base polymer A, 0.3 parts of commercially available fine particles “SEAHOSTAR KE-P50” (produced by NIPPON SHOKUBAI CO., LTD) and 70 parts of toluene.

### (6) Preparation of Dope E

Dope E was prepared by mixing 29.7 parts of Cycloolefin base polymer A, 0.3 parts of commercially available fine particles “SEAHOSTAR KE-P100” (produced by NIPPON SHOKUBAI CO., LTD) and 70 parts of toluene.

### (7) Preparation of Film B (a Polymer Film to be Used as Second Optically Anisotropic Layer)

Dope A, containing no fine particles, and dope B, containing fine particles, were co-cast on a band according to the three-layers co-casting method so that the layer construction is a B-A-B structure, and dried by heat wind at 100 degrees Celsius. The film having a residual solvent content of about 22% by mass was peeled away from the band, then dried by heat wind at 140 degrees Celsius while being transported by rolls, and then winded up. Subsequently, using a tenter, this was stretched in the cross section at a stretching ratio of 80% under an atmosphere at 180 degrees Celsius, and winded up. In this way, biaxially-stretched film, Film B, was obtained.

Film B had an inner layer having a thickness of 50 μm, and two outer layers on the both sides thereof having a thickness of 5 μm.

Film B had Re(550) of 80 nm and Rth(550) of 60 nm, which were measured at a wavelength of 550 nm by using KOBRA 21ADH (by Oji Scientific Instruments).

### (8) Preparation of Film C (a Polymer Film to be Used as Second Optically Anisotropic Layer)

Film C was prepared in the same manner as Film B, except that dope C was used in place of dope B.

The thicknesses of the inner and outer layers and the optical properties of Film C were nearly same as those of Film B.

### (9) Preparation of Film D (a Polymer Film to be Used as Second Optically Anisotropic Layer)

Film D was prepared in the same manner as Film B, except that dope D was used in place of dope B.

The thicknesses of the inner and outer layers and the optical properties of Film D were nearly same as those of Film B.

### (10) Preparation of Film E (a Polymer Film to be Used as Second Optically Anisotropic Layer)

Film E was prepared in the same manner as Film B, except that dope E was used in place of dope B.

The thicknesses of the inner and outer layers and the optical properties of Film E were nearly same as those of Film B.

### (11) Preparation of Film F (a Polymer Film to be Used as Second Optically Anisotropic Layer)

Film F was prepared in the same manner as Film B, except that the co-casting was carried out so that the thicknesses of the outer layers were 10 μm and the thickness of the inner layer was 40 μm.

The optical properties of Film F were nearly same as those of Film B.

### (12) Preparation of Film G (a Polymer Film to be Used as Second Optically Anisotropic Layer)

Film G was prepared in the same manner as Film B, except that dope B, containing fine particles, was cast alone.

The thickness of Film G was 60 μm; and the optical properties thereof were nearly same as those of Film B,

(13) Measurements of Mean Particle Diameter (r) of Fine Particles and |Δn|·r, and Evaluations.

Regarding refractive indexes of commercially available fine particles (R972, KE-P50 and KE-P100), the data described in the catalogs were used; and regarding refractive index of Cycloolefin base polymer A, the data measured by using an Abbe refractometer was used. The refractive indexes of the materials are as follows:

Fine particles R972: n=1.46

Fine particles KE-P50 and KE-P100: n=1.42 and

Cycloolefin base polymer A: n=1.52.

The mean particle diameter “r” of fine particles means a mean size of fine particles residing in the film or in the film plane; and it is an averaged value of approximate circle diameters of 100 numbers of fine particles, which are observed in SEM or TEM photographs, regardless of whether they are aggregate or non-aggregate. The approximate circle diameter is obtained by converting the project areas of the fine particles, which are observed in SEM or TEM photographs, to the diameters found in the circles having the same areas. The mean particle diameters of the fine particles are as follows:

Fine particles R972: r=0.2 (μm)

Fine particles KE-P50: r=0.5 (μm) and

Fine particles KE-P100: r=1.0 (μm).

### 2. Preparations and Evaluations of Optical Films

### 2.-1 Example 1

### (1) Surface Treatment of Polymer Film to be Used as Second Optically Anisotropic Layer

While being fed, Film B was subjected to glow discharge treatment between a pair of brass electrodes, to which high frequency electric pressure of 3000 Hz and 4200V was applied for 20 seconds, under an argon atmosphere.

### (2) Preparation of Alignment Layer

A coating liquid, having a formulation shown below, was applied to the surface, which was subjected to the surface treatment, of Film B by using a wire bar coater of #14 in the amount of 24 ml/m². And the liquid was dried by a warm wind at 100 degrees Celsius for 120 seconds to form a layer. After that, the surface of the layer was subjected to a rubbing treatment in 0°-direction, which is parallel to a long direction (machine direction) of Film B to form an alignment layer.

### Formulation of Coating Liquid of Alignment Layer:

| | | |
|---|---|---|
| Modified polyvinyl alcohol shown below | 40 | parts by mass |
| Water | 728 | parts by mass |
| Methanol | 228 | parts by mass |
| Glutaraldehyde(crosslinking agent) | 2 | parts by mass |
| Citrate (AS3 produced by Sankyo Chemical) | 0.69 | parts by mass |

Modified polyvinyl alcohol

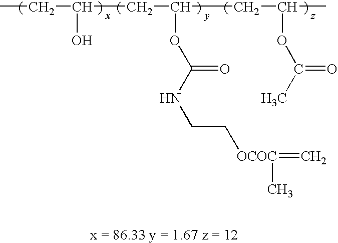

### (3) Preparation of First Optically Anisotropic Layer

A coating liquid to be used for preparing a first optically anisotropic layer, having the formulation shown below, was prepared.

### Formulation of Coating Liquid of First Optically Anisotropic Layer:

| | | |
|---|---|---|
| Discotic liquid crystal compound A shown below | 100 | parts by mass |
| Fluorinated surfactant A shown below | 1 | part by mass |
| Photopolymerization initiator (Irgacure 907, by Ciba-Geigy) | 3 | parts by mass |
| Sensitizer(Kayacure DETX, by Nippon Kayaku) | 1 | part by mass |
| Methylethyl ketone | 340 | parts by mass |

Discotic liquid crystal compound A

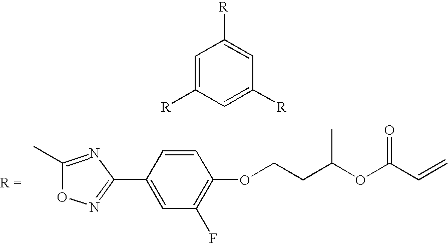

Fluorinated surfactant A

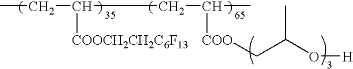

The coating liquid for formation of optically-anisotropic layer mentioned above was continuously applied onto the rubbed surface of the film using a wire bar of #2 9 which was rotated at a ratio of 1,406 rotations/minute in the machine direction while the film was fed at the ratio of 36 m/minute. Then, after elevating the temperature from the room temperature to 100 degrees Celsius continuously for drying the solvent in the liquid, the liquid was heated in a drying zone at 115 degrees Celsius for 90 seconds to align molecules of the discotic compound. And the film was fed into a drying zone at 80 degrees Celsius, and was irradiated with UV ray having lighting intensity of 600 mW by using a UV irradiation equipment having a metal halide lamp (output: 160 W/cm, emission length: 1.6 m) for four seconds, to carry out the crosslinking reaction and then fix the alignment state of the discotic liquid crystal compound. After that, the film was cooled by the room temperature, and winded up. In this way, Optical film of Example 1 was obtained in a wind-up form.

### (4) Measurement of Surface Roughness Ra

The surface roughness Ra of the first optically anisotropic layer was measured by using AFM (Atomic Force Microscope, “SPI3800N” by SEIKO Instruments). The result is shown in the table below.

### (5) Measurement of Dynamic Friction Coefficient

Two pieces, having a size of 80 mm×200 mm, were cut out from the optical film, and were left in an atmosphere of 23 degrees Celsius and 55% RH for 16 hours. After that, using the two pieces, the dynamic friction coefficient between the two sides of the optical film was measured according to a method of JIS K7125. the result was shown in the table below.

### (6) Evaluation of Winkles

The optical film having a 100 m length was prepared as a sample, and the number of wrinkles found in the terminal 10 m portion of the sample was counted by eyes. Evaluation was carried out according to the criteria shown below.

A: no wrinkle was found.

B: one or two wrinkles were found.

C: three or more wrinkles were found.

The result was shown in the table below.

### (7) Measurement of Haze

A piece, having a size of 35 mm×120 mm, was cut out from the optical film, and was left in an atmosphere of 23 degrees Celsius and 55% RH for 16 hours. After that, regarding three points of the sample piece, haze was respectively measured by using a haze meter (“NDH 2000” by NIPPON DENSHOKU INDUSTRIES CO., LTD.); and the averaged value of the three data was calculated as haze. The result was shown in the table below.

### 2.-2 Example 2

Optical film of Example 2 was prepared in the same manner as Optical film of Example 1, except that Fluorinated surfactant B shown below was used in place of Fluorinated surfactant A in preparing the first optically anisotropic layer. The obtained optical film was evaluated in the same manner as Example 1. The result was shown in the table below.

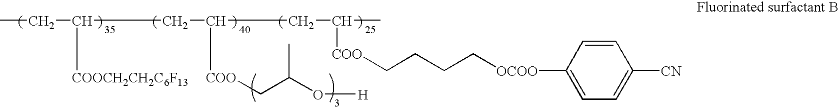

### 2.-3 Example 3

Optical film of Example 3 was prepared in the same manner as Optical film of Example 1, except that Fluorinated surfactant C shown below was used in place of Fluorinated surfactant A in preparing the first optically anisotropic layer. The obtained optical film was evaluated in the same manner as Example 1. The result was shown in the table below.

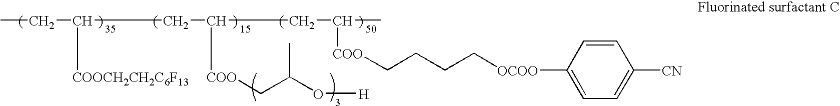

### 2.-4 Example 4

Optical film of Example 4 was prepared in the same manner as Optical film of Example 1, except that Fluorinated surfactant D shown below was used in place of Fluorinated surfactant A in preparing the first optically anisotropic layer. The obtained optical film was evaluated in the same manner as Example 1. The result was shown in the table below.

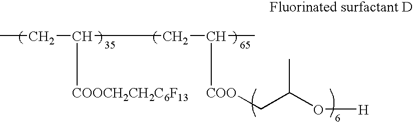

### 2.-5 Example 5

Optical film of Example 5 was prepared in the same manner as Optical film of Example 1, except that Fluorinated surfactant E shown below was used in place of Fluorinated surfactant A in preparing the first optically anisotropic layer. The obtained optical film was evaluated in the same manner as Example 1. The result was shown in the table below.

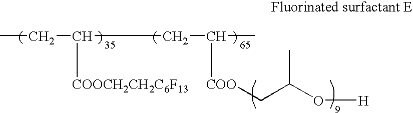

### 2.-6 Example 6

Optical film of Example 6 was prepared in the same manner as Optical film of Example 1, except that Fluorinated surfactant F shown below was used in place of Fluorinated surfactant A in preparing the first optically anisotropic layer. The obtained optical film was evaluated in the same manner as Example 1. The result was shown in the table below.

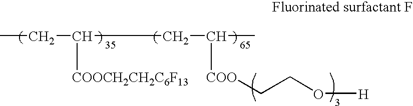

### 2.-7 Example 7

Optical film of Example 7 was prepared in the same manner as Optical film of Example 1, except that Fluorinated surfactant G shown below was used in place of Fluorinated surfactant A in preparing the first optically anisotropic layer. The obtained optical film was evaluated in the same manner as Example 1. The result was shown in the table below.

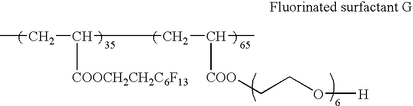

### 2.-8 Example 8

Optical film of Example 8 was prepared in the same manner as Optical film of Example 1, except that Fluorinated surfactant H shown below was used in place of Fluorinated surfactant A in preparing the first optically anisotropic layer. The obtained optical film was evaluated in the same manner as Example 1. The result was shown in the table below.

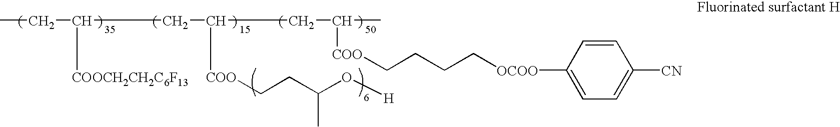

### 2.-9 Example 9

Optical film of Example 9 was prepared in the same manner as Optical film of Example 1, except that Fluorinated surfactant I shown below was used in place of Fluorinated surfactant A in preparing the first optically anisotropic layer. The obtained optical film was evaluated in the same manner as Example 1. The result was shown in the table below.

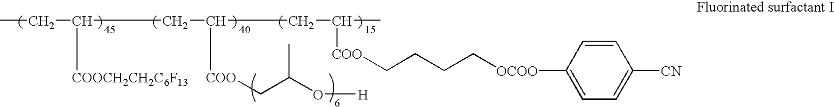

### 2.-10 Example 10

Optical film of Example 10 was prepared in the same manner as Optical film of Example 1, except that Film F was used as the second optically anisotropic layer in place of Film B, and except that Fluorinated surfactant J shown below was used in place of Fluorinated surfactant A in preparing the first optically anisotropic layer. The obtained optical film was evaluated in the same manner as Example 1. The result was shown in the table below.

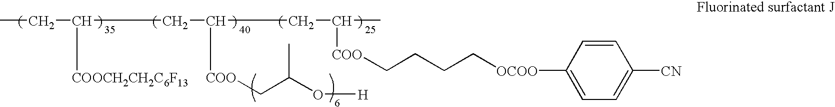

### 2.-11 Example 11

Optical film of Example 11 was prepared in the same manner as Optical film of Example 1, except that Film C was used as the second optically anisotropic layer in place of Film B, and except that Fluorinated surfactant J was used in place of Fluorinated surfactant A in preparing the first optically anisotropic layer. The obtained optical film was evaluated in the same manner as Example 1. The result was shown in the table below.

### 2.-12 Example 12

Optical film of Example 12 was prepared in the same manner as Optical film of Example 1, except that Film G was used as the second optically anisotropic layer in place of Film B, and except that Fluorinated surfactant B was used in place of Fluorinated surfactant A in preparing the first optically anisotropic layer. The obtained optical film was evaluated in the same manner as Example 1. The result was shown in the table below.

### 2.-13 Example 13

Dope A, containing no fine particles, and dope B, containing fine particles, were co-cast on a band according to the two-layers co-casting method so that the layer construction is a B-A structure, and dried by heat wind at 100 degrees Celsius. The film having a residual solvent content of about 22% by mass was peeled away from the band, then dried by heat wind at 140 degrees Celsius while being transported by rolls, and then winded up. Subsequently, using a tenter, this was stretched in the cross section at a stretching ratio of 80% under an atmosphere at 180 degrees Celsius, and winded up. In this way, biaxially-stretched film, Film H, was obtained. Subsequently, an alignment layer was formed on the side of the layer formed of dope A, and then was subjected to a rubbed treatment. And subsequently a first optically anisotropic layer was formed in the same manner as Example 1, except that Fluorinated surfactant B was used in place of Fluorinated surfactant A. In this way, Optical film of Example 13 was prepared continuously, and then evaluated in the same manner described above.

Separately from the above process, Film H was prepared in the same manner described above; and it was found that the thickness of the outer layer thereof was 5 μm and the thickness of the inner layer thereof was 55 μm. The optical properties of Film H were nearly equal to those of Film B.

### 2.-14 Example 14

Optical film of Example 14 was prepared in the same manner as Optical film of Example 1, except that Film D was used as the second optically anisotropic layer in place of Film B, and except that Fluorinated surfactant J was used in place of Fluorinated surfactant A in preparing the first optically anisotropic layer. The obtained optical film was evaluated in the same manner as Example 1. The result was shown in the table below.

### 2.-15 Example 15

Optical film of Example 15 was prepared in the same manner as Optical film of Example 1, except that Film E was used as the second optically anisotropic layer in place of Film B, and except that Fluorinated surfactant J was used in place of Fluorinated surfactant A in preparing the first optically anisotropic layer. The obtained optical film was evaluated in the same manner as Example 1. The result was shown in the table below.

### 2.-16 Comparative Example 1

Film A was prepared continuously in the same manner as Film H, except that dope A was cast alone on a band. And Film A was subjected to a surface treatment with glow discharge; and then on the treated surface of Film A, an alignment layer was formed. Further subsequently, a first optically anisotropic layer was prepared in the same manner as Example 13, except that Fluorinated surfactant K shown below was used in place of Fluorinated surfactant J. In this way, Optical film of Comparative Example 1 was prepared continuously, and then evaluated in the same manner described above.

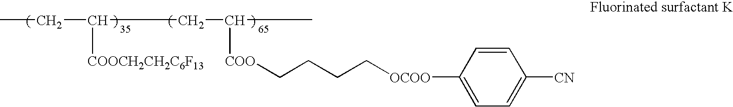

Separately from the above process, Film A was prepared in the same manner described above; and it was found that the thickness of the film was 60 μm. The optical properties of Film H were nearly equal to those of Film B.

### 2.-17 Comparative Example 2

Optical film of Comparative example 2 was prepared in the same manner as Example 1, except that Fluorinated surfactant L shown below was used in place of Fluorinated surfactant A in preparing the first optically anisotropic layer. The obtained optical film was evaluated in the same manner as Example 1. The result was shown in the table below.

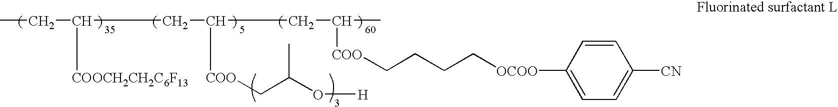

TABLE

| | Second | | | | | | | | | |
|---|---|---|---|---|---|---|---|---|---|---|
| | optically | | Formula (II) | | | Mw of | | Dynamic | | |
| | anisotropic | | Mole | | number of | Fluorinated | | friction | Evaluation | |
| | layer | \|Δn\| · r | ratio | Type | replication | surfactant | Ra/nm | coefficient | of Wrinkles | Haze |
| Example 1 | B | 0.012 | 65 | Propylene oxy | 3 | 25000 | 2.0 | 0.5 | A | 0.8 |
| Example 2 | B | 0.012 | 40 | Propylene oxy | 3 | 18000 | 1.5 | 0.6 | A | 0.8 |
| Example 3 | B | 0.012 | 15 | Propylene oxy | 3 | 30000 | 0.8 | 0.9 | B | 0.6 |
| Example 4 | B | 0.012 | 65 | Propylene oxy | 6 | 26000 | 1.5 | 0.6 | A | 0.8 |
| Example 5 | B | 0.012 | 65 | Propylene oxy | 9 | 9000 | 0.9 | 0.8 | A | 0.6 |
| Example 6 | B | 0.012 | 65 | Propylene oxy | 3 | 22000 | 1.2 | 0.7 | A | 0.7 |
| Example 7 | B | 0.012 | 65 | Propylene oxy | 6 | 25000 | 0.8 | 0.9 | B | 0.6 |
| Example 8 | B | 0.012 | 15 | Propylene oxy | 6 | 28000 | 1.2 | 0.7 | A | 0.7 |
| Example 9 | B | 0.012 | 40 | Propylene oxy | 6 | 32000 | 1.1 | 0.7 | A | 0.7 |
| Example 10 | F | 0.012 | 40 | Propylene oxy | 6 | 25000 | 1.0 | 0.7 | A | 0.9 |
| Example 11 | C | 0.012 | 40 | Propylene oxy | 6 | 25000 | 1.0 | 1.0 | B | 0.5 |
| Example 12 | G | 0.012 | 40 | Propylene oxy | 3 | 35000 | 1.5 | 0.6 | A | 1.9 |
| Example 13 | H | 0.012 | 40 | Propylene oxy | 6 | 25000 | 1.5 | 0.6 | A | 0.5 |
| Example 14 | D | 0.050 | 40 | Propylene oxy | 6 | 25000 | 1.0 | 0.6 | A | 1.2 |
| Example 15 | E | 0.100 | 40 | Propylene oxy | 6 | 25000 | 1.0 | 0.5 | A | 2.5 |
| Comparative | A | — | — | — | — | 20000 | 0.3 | 2.3 | C | 0.3 |
| Example 1 | | | | | | | | | | |
| Comparative | B | 0.012 | 5 | Propylene oxy | 3 | 24000 | 0.4 | 1.6 | C | 0.5 |
| Example 2 | | | | | | | | | | |

### 3. Preparations and Evaluations of Polarizing Plates

A polyvinyl alcohol (PVA) film having a thickness of 80 μm was dipped and dyed in an aqueous iodine solution having an iodine concentration of 0.05% by mass, at 30 degrees Celsius for 60 seconds, and then dipped in an aqueous boric acid solution having a boric acid concentration of 4% by mass, for 60 seconds, and while dipped therein, this was stretched 5-fold in the machine direction. Next, this was dried at 50 degrees Celsius for 4 minutes, and a polarizing film having a thickness of 20 μm was thus obtained.

A commercially available cellulose acetate film (FUJITAC TF80UL by FUJIFILM Corporation) was dipped in an aqueous sodium hydroxide solution of 1.5 mol/L at 55 degrees Celsius, and then sodium hydroxide was well washed away with water. Next, this was dipped in an aqueous diluted sulfuric acid solution of 0.005 mol/L at 35 degrees Celsius for 1 minute, and then dipped in water to fully wash away the aqueous diluted sulfuric acid solution. Finally, the sample was fully dried at 120 degrees Celsius.

Each of Optical films of Examples 1-15 was combined with the saponified commercial-available cellulose acetate film, and these were stuck with the above-mentioned polarizing film sandwiched therebetween, using a polyvinyl alcohol adhesive to give a polarizing plate. Each of the optical films was stuck so that the first optically anisotropic layer was at the out side. In this, the polarizing film and the protective film on both sides of the polarizing film were formed each as a roll, and therefore the machine direction of the individual roll films was in parallel to each other and the films were continuously stuck. Accordingly, the long direction of each of the optical roll films (the slow axis of the cycloolefin base polymer film) was parallel to the absorption axis of the polarizing element.

Using optical films of Comparative Examples 1 and 2, sticking with the polarizing film could not be carried out since there were may wrinkles in the films.

### 4. Preparations and Evaluations of TN Mode Liquid Crystal Display Devices

A pair of polarizing plates originally in a liquid-crystal display device (AL2216W, by Nippon Acer) with a TN-mode liquid-crystal cell therein were peeled off, and in place of them, the polarizing plates fabricated in the above were incorporated into it. Briefly, on the viewers' side and on the backlight side of the device, each one polarizing plate was stuck via an adhesive in such a manner that the optical film faced the liquid-crystal cell, or that is, the first optically anisotropic layer was disposed most closely to the liquid crystal cell. In this, the two polarizing plates were so disposed that the transmission axis of the polarizing plate on the viewers' side was perpendicular to the transmission axis of the polarizing plate on the backlight side.

Using a brightness meter (TOPCON's BM-5), the brightness in the white and black states was measured in the normal direction and in the upper-, downward-, rightward- and leftward-oblique directions with a polar angle of 80 degrees, regarding each of the liquid crystal display devices. And the contrasts in the directions were calculated as a ratio of the white brightness to the black brightness; and then the contrast in the normal direction and the averaged contrast in the upper-, downward-, rightward- and leftward-oblique directions were calculated. The results were shown in the table below.

TABLE

| | CR*1 | Averaged CR*2 |
|---|---|---|
| Example 1 | 1050 | 61 |
| Example 2 | 1050 | 61 |
| Example 3 | 1200 | 65 |
| Example 4 | 1050 | 61 |
| Example 5 | 1200 | 65 |
| Example 6 | 1100 | 63 |
| Example 7 | 1200 | 65 |
| Example 8 | 1100 | 63 |
| Example 9 | 1100 | 63 |
| Example 10 | 1000 | 59 |
| Example 11 | 1250 | 67 |
| Example 12 | 700 | 45 |
| Example 13 | 1250 | 67 |
| Example 14 | 900 | 54 |
| Example 15 | 600 | 40 |

*1Contrast in the normal direction
*2Averaged contrast in the upper-, downward, rightward, and leftward directions

What is claimed is:

1. An optical film comprising:
a first optically anisotropic layer formed of a composition comprising, at least, a liquid crystal compound and a fluorinated surfactant, and
a second optically anisotropic layer comprising at least one selected from the group consisting of cycloolefin base homopolymers and copolymers,
wherein a dynamic friction coefficient between the two sides of the optical film is equal to or smaller than 1.0.

2. The optical film of claim 1, wherein the first optically anisotropic layer has a surface roughness of equal to or more than 0.8 nm.

3. The optical film of claim 1, wherein the fluorinated surfactant has one or more poly(alkyleneoxy) groups.

4. The optical film of claim 1, wherein the fluorinated surfactant is a polymer comprising a repeating unit derived from a compound represented by formula (I) and a repeating unit derived from a compound represented by formula (II); and the molar ratio of the repeating unit of formula (II) in the polymer is equal to or more than 10% by mole: 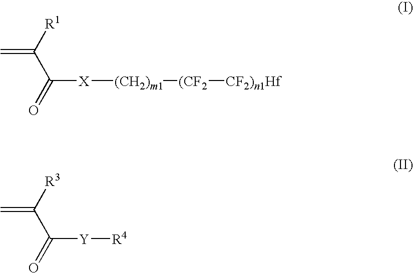
where Hf represents a hydrogen atom or fluorine atom; R¹ represents a hydrogen atom or methyl; X represents an oxygen atom, sulfur atom or —N(R²)—; m1 is an integer of from 1 to 6; n1 is an integer of from 2 to 4; R² represents a hydrogen atom or C₁₋₄ alkyl; R³ represents a hydrogen atom or methyl; Y represents a bivalent liking group; and R⁴ represents a poly(alkyleneoxy) group which may have at least one substituent.

5. The optical film of claim 4, wherein the monomer represented by formula (II) is a compound represented by formula (II′) shown below: 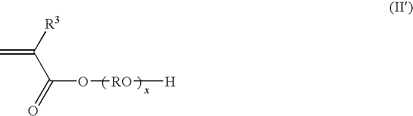
where R³ has a same meaning as that defined in formula (II); R represents a C₂₋₄ alkylene; x is an integer from 2 to 10, provided that plural alkyleneoxy units, RO, are same or different from each other.

6. The optical film of claim 1; wherein the one liquid crystal compound is a discotic compound.

7. The optical film of claim 1, wherein the second optically anisotropic layer comprises inorganic fine particles and/or polymer fine particles.

8. The optical film of claim 6, wherein |Δn|, which is an absolute value of the difference in refractive index between the particles and at least one selected from the group consisting of cycloolefin base homopolymers and copolymers, and r (μm), which is the mean particle diameter of the particles, meet |Δn|·r≦0.05 (μm).

9. A polarizing plate comprising a polarizing film and an optical film according to claim 1.

10. A liquid crystal display comprising a liquid crystal cell and a polarizing plate according to claim 9.

11. The liquid crystal display of claim 10, wherein the liquid crystal cell employs a TN-mode.
